(19) United States
(12) Patent Application Publication
(10) Pub. No.: US 2011/0007402 A1
(43) Pub. Date: Jan. 13, 2011

(54) PROJECTION VARIABLE FOCUS LENS AND PROJECTION DISPLAY DEVICE

(76) Inventor: Masaru AMANO, Saitama-shi (JP)

Correspondence Address: BIRCH STEWART KOLASCH & BIRCH, PO BOX 747, FALLS CHURCH, VA, 22040-0747, US

(21) Appl. No.: 12/824,973

(22) Filed: Jun. 28, 2010

(30) Foreign Application Priority Data
Jul. 9, 2009 (JP) P2009-162501

(51) Int. Cl. G02B 3/00

(52) U.S. Cl. 359/649

(57) ABSTRACT

An inexpensive projection variable focus lens includes six lenses and three or less lens groups which are moved when power varies, is telecentric, and is capable of effectively reducing all aberrations including astigmatism. Also, a projection display device includes the projection variable focus lens.

The six lenses include a first lens provided closest to a magnification side and having a negative refractive power, and a second lens from the magnification side that has a positive refractive power. The reduction side of a lens system is telecentric. The six lenses are classified into three or more lens groups. Three or less of the three or more lens groups are moved to change a focal length. When the focal length varies from a wide angle end to a telephoto end, at least the second lens is moved from the reduction side to the magnification side along an optical axis.

### CROSS-REFERENCE TO RELATED APPLICATIONS

This application is based upon and claims the benefit of priority from the Japanese Patent Application No. 2009-162501 filed on Jul. 9, 2009; the entire contents of which are incorporated herein by reference.

### BACKGROUND OF THE INVENTION

1. Field of the Invention

The present invention relates to a variable focus lens that includes six lenses and is provided in, for example, a projection display device, and a projection display device including the variable focus lens, and more particularly, to a small projection variable focus lens and a projection display device which enlarge and project light having image information from a light valve of, for example, a transmissive or reflective liquid crystal display device or a DMD (digital micro-mirror device) display device onto a screen.

2. Description of the Related Art

In recent years, projection display devices using light valves, such as liquid crystal display devices or DMD display devices, have come into widespread use. In particular, a projection display device has been widely used which uses three light valves corresponding to illumination light components of three primary colors, such as R, G, and B, to modulate the illumination light components, and combines the light components modulated by the three light valves using, for example, a color composition prism, and displays an image on a screen through a projection lens.

In many cases, the projection display device uses as a projection lens a variable focus lens (zoom lens) capable of changing the size of the image projected onto the screen. A telecentric variable focus lens including four lens groups or five lens groups is generally used as the projection variable focus lens. When high performance or a high zoom ratio is required, a variable focus lens including six lens groups is used.

In general, the variable focus lens includes a large number of lenses in order to achieve high aberration characteristics, ensure telecentricity, and prevent a reduction in contrast or the occurrence of color unevenness. However, when the number of lenses increases, manufacturing costs also increase. Therefore, it is necessary to construct a variable focus lens capable of achieving the objects with a minimum number of lenses.

In order to meet the requirements, Japanese Patent Nos. 4206769 (corresponding to US 2004/0257644 A) and 4206708 and JP-A-2007-206331 disclose projection variable focus lenses each including six lenses.

However, in the projection zoom lens including six lenses disclosed in Japanese Patent No. 4206769, four lens groups are moved when power varies. Therefore, a moving mechanism including, for example, a cam becomes complicated, and the weight of the projection zoom lens or the difficulty of manufacture increases, which results in an increase in manufacturing costs.

In the projection zoom lens including six lenses disclosed in Japanese Patent No. 4206708 and JP-A-2007-206331, when power varies, the variation in astigmatism is too large. Therefore, it is necessary to reduce the variation in astigmatism.

### SUMMARY OF THE INVENTION

One embodiment of the invention may provide an inexpensive projection variable focus lens that includes six lenses and three or less lens groups moved when power varies, has telecentricity, and is capable of effectively reducing all aberrations including astigmatism, and a projection display device including the projection variable focus lens.

According to an aspect of the invention, a projection variable focus lens includes six lenses. The six lenses include a first lens and a second lens. The first lens is provided closest to a magnification side and has a negative refractive power. The second lens from the magnification side has a positive refractive power and is telecentric on a reduction side. The six lenses are classified into three or more lens groups. Three or less of the three or more lens groups are moved to change a focal length. When the focal length varies from a wide angle end to a telephoto end, the second lens is moved from the reduction side to the magnification side along an optical axis.

The three or more lens group may include a first lens group including the first lens. The first lens group may satisfy the following Conditional expression 1:

−2.5<f₁/f_{w}<−0.5 [Conditional expression 1]

(where f_{w} indicates the focal length of the entire system at the wide angle end, and f₁ indicates a focal length of the first lens).

The three or more lens groups may include a second lens group that is arranged on the reduction side of the first lens group. The second lens group may satisfy the following Conditional expression 2:

1.0<f₂/f_{w}<4.0 [Conditional expression 2]

(where f_{w} indicates the focal length of the entire system at the wide angle end, and f₂ indicates a focal length of the second lens).

The first lens may have at least one aspheric surface.

The six lenses may include a third lens from the magnification side that has a positive refractive power and includes a convex surface facing the reduction side.

The six lenses may include a fourth lens, a fifth lens and a sixth lens. The fourth lens from the magnification side has a negative refractive power. The fifth lens from the magnification side has a positive refractive power. The sixth lens from the magnification side has a positive refractive power.

According to another aspect of the invention, a projection display device includes a light source, a light valve, an illumination optical unit, and the projection variable focus lens according to the above-mentioned aspect. The illumination optical unit guides light emitted from the light source to the light valve. The light valve modulates the light emitted from the light source. The modulated light is projected onto a screen by the projection variable focus lens.

The meaning of the ‘variable focus lens’ includes a varifocal lens and a zoom lens. The varifocal lens performs a focusing operation to adjust defocusing when the conjugation length is changed due to power variation, unlike the zoom lens.

The ‘magnification side’ means an object side (screen side). In the case of reduced projection, for convenience, the screen side is also referred to as the magnification side. The ‘reduction side’ means an original image display area side (light valve side). In the case of reduced projection, for convenience, the light valve side is also referred to as the reduction side.

In the projection variable focus lens according to the above-mentioned aspect of the invention, the first lens arranged closest to the magnification side is a negative lens and the lens group with a negative refractive power is disposed at the head. Therefore, it is possible to ensure a wide angle of view and a large back focal length with a relatively simple structure.

When power varies, the positive second lens is moved from the reduction side to the magnification side along the optical axis. In this way, the second lens serves a power varying group as well as a correction group, and it is possible to prevent variation in aberration (particularly, astigmatism or field curvature) over the entire power variable range. In addition, it is possible to form a high-performance projection variable focus lens with a small number of lenses.

That is, since the first lens is a negative lens, both an on-axis light beam and an off-axis light beam are incident on the second lens at a large height. When the second lens is a positive lens, it is possible to largely correct aberration of the off-axis light beam, such as astigmatism. However, in the case of a variable focus lens, the large aberration correction acts as a defect and a large variation in aberration (particularly, astigmatism) occurs due to the movement of the lenses when power varies. However, in the projection variable focus lens according to the above-mentioned aspect of the invention, in order to prevent the variation in aberration when power varies, the second lens is moved from the reduction side to the magnification side when power varies from the wide angle end to the telephoto end. In addition, when power varies, the height of the off-axis light beam incident on the second lens is maintained to be constant. Therefore, it is possible to consistently obtain the effect of correcting off-axis aberration, such as astigmatism. At the same time, it is possible to reduce the amount of astigmatism.

The projection display device uses the projection variable focus lens according to one aspect of the invention. Therefore, the projection display device has low manufacturing costs and a light weight and can effectively correct all aberrations including astigmatism.

### BRIEF DESCRIPTION OF THE DRAWINGS

FIG. 1 is a diagram illustrating the structure of a projection variable focus lens according to Example 1 of the invention;

FIG. 2 is a diagram illustrating the structure of a projection variable focus lens according to Example 2 of the invention;

FIG. 3 is a diagram illustrating the structure of a projection variable focus lens according to Example 3 of the invention;

FIG. 4 is a diagram illustrating the structure of a projection variable focus lens according to Example 4 of the invention;

FIG. 5 is a diagram illustrating the structure of a projection variable focus lens according to Example 5 of the invention;

FIG. 6 is a diagram illustrating the structure of a projection variable focus lens according to Example 6 of the invention;

FIG. 7 is a diagram illustrating the structure of a projection variable focus lens according to Example 7 of the invention;

FIG. 8 is a diagram illustrating the structure of a projection variable focus lens according to Example 8 of the invention;

FIG. 9 is a diagram illustrating the structure of a projection variable focus lens according to Example 9 of the invention;

FIG. 10 is a diagram illustrating the structure of a projection variable focus lens according to Example 10 of the invention;

FIG. 11 is a diagram illustrating the structure of a projection variable focus lens according to Example 11 of the invention;

FIG. 12 is a diagram illustrating the structure of a projection variable focus lens according to Example 12 of the invention;

FIG. 13 is a diagram illustrating the structure of a projection variable focus lens according to Example 13 of the invention;

FIG. 14 is a diagram illustrating the structure of a projection variable focus lens according to Example 14 of the invention;

FIG. 15 is a diagram illustrating the structure of a projection variable focus lens according to Example 15 of the invention;

FIG. 16 is a diagram illustrating all aberrations of the projection variable focus lens according to Example 1;

FIG. 17 is a diagram illustrating all aberrations of the projection variable focus lens according to Example 2;

FIG. 18 is a diagram illustrating all aberrations of the projection variable focus lens according to Example 3;

FIG. 19 is a diagram illustrating all aberrations of the projection variable focus lens according to Example 4;

FIG. 20 is a diagram illustrating all aberrations of the projection variable focus lens according to Example 5;

FIG. 21 is a diagram illustrating all aberrations of the projection variable focus lens according to Example 6;

FIG. 22 is a diagram illustrating all aberrations of the projection variable focus lens according to Example 7;

FIG. 23 is a diagram illustrating all aberrations of the projection variable focus lens according to Example 8;

FIG. 24 is a diagram illustrating all aberrations of the projection variable focus lens according to Example 9;

FIG. 25 is a diagram illustrating all aberrations of the projection variable focus lens according to Example 10;

FIG. 26 is a diagram illustrating all aberrations of the projection variable focus lens according to Example 11;

FIG. 27 is a diagram illustrating all aberrations of the projection variable focus lens according to Example 12;

FIG. 28 is a diagram illustrating all aberrations of the projection variable focus lens according to Example 13;

FIG. 29 is a diagram illustrating all aberrations of the projection variable focus lens according to Example 14;

FIG. 30 is a diagram illustrating all aberrations of the projection variable focus lens according to Example 15; and

FIG. 31 is a diagram illustrating the structure of a main part of a projection display device according to an embodiment of the invention.

### DESCRIPTION OF THE PREFERRED EMBODIMENTS

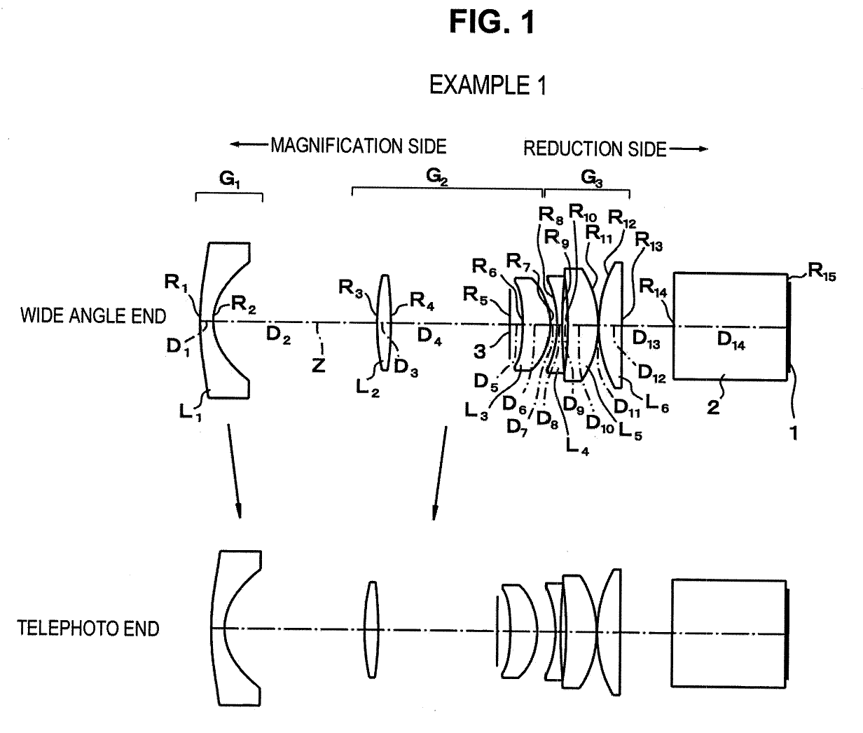

Hereinafter, exemplary embodiments of the invention will be described with reference to the accompanying drawings. A projection variable focus lens according to an embodiment of the invention shown in FIG. 1 (a projection variable focus lens according to Example 1 is shown as a representative example) includes six lenses. A first lens L₁ that is arranged closest to a magnification side is a negative lens and a second lens L₂ from the magnification side is a positive lens. The reduction side of the lens system is telecentric.

The six lenses are classified into three or more lens groups (three lens groups in Examples 1 to 10, four lens groups in Examples 11 to 14, and five lens groups in Example 15). When the focal length varies (including power variation; hereinafter, simply referred to as ‘when power varies’), three or less lens groups (two lens groups in Examples 1 to 8 and 11 to 14 and three lens groups in Examples 9, 10, and 15) among the lens groups are moved to change the focal length. When the focal length is changed from a wide angle end to a telephoto end, at least the second lens L₂ is moved from the reduction side to the magnification side along an optical axis Z.

For example, as shown in FIG. 1, a glass block 2, which is mainly a color composition prism, and image display surfaces 1 of three or more light valves, such as liquid crystal display panels, are provided in the rear stage of the lens system. However, in a so-called single panel type using one light valve, the color composite prism is not needed.

Although not shown in FIG. 1, for example, a mask 3 may be arranged in a second lens group G₂ or at other positions.

In the specification, the ‘mask’ has a function of shielding some of light beams below or above an off-axis light beam. The light-shielding operation makes it possible to maintain the balance between the light beams above or below the off-axis light beam and prevent the occurrence of color unevenness.

The mask may be an aperture diaphragm that limits the light beams above and below the off-axis light beam and regulates the brightness.

During focusing, for example, one lens group (the first lens group in Examples 1 to 6, 9, 10, and 15 and the third lens group in Examples 7, 8, and 11 to 14) is moved along the optical axis Z.

As such, in the projection variable focus lens according to this embodiment, the first lens closest to the magnification side is a negative lens. Therefore, it is possible to easily ensure a wide angle of view and a large back focal length.

When power varies, the positive second lens L₂ is moved from the reduction side to the magnification side along the optical axis. In this way, the second lens L₂ can serve as a power varying group as well as an aberration correcting group, and it is possible to prevent a variation in aberration, particularly, astigmatism or field curvature over the entire power variable range. Therefore, it is possible to form a high-performance projection variable focus lens with a small number of lenses.

That is, as power varies from the wide angle end to the telephoto end, the second lens L₂ is moved from the reduction side to the magnification side. When power varies, the height of the off-axis light beam incident on the second lens L₂ is maintained to be constant. Therefore, it is possible to obtain the effect of correcting an off-axis aberration, such as astigmatism, all the time. At the same time, it is possible to reduce the astigmatism.

The lens system includes six lenses having the above-mentioned structure. As such, a zoom lens or a so-called varifocal lens may be formed by a small number of lenses. Therefore, the zoom lens or the varifocal lens has a simpler structure. In this case, it is possible to remove restrictions in the cooperative movement of the lens groups when power varies. Therefore, it is possible to significantly reduce variation in aberration when power varies.

The concept of the ‘variable focus lens’ includes a so-called varifocal lens and a zoom lens. The ‘varifocal lens’ requires a focusing operation corresponding to defocusing when the conjugation length varies during power variation. In the structure in which two lens groups are moved when power varies, two moving groups are independently moved. Therefore, a complicated lens driving mechanism, such as a cam mechanism for cooperatively moving the moving lens groups, is not needed.

The conjugation length of the ‘zoom lens’ is adjusted to be constant when power varies and a small amount of deviation of the conjugation length is adjusted by the focus lens, as compared to the ‘varifocal lens’. However, in the zoom lens, when power varies, two or more moving groups are moved by, for example, a cam mechanism for zooming according to a predetermined rule. Therefore, in general, the disadvantages of the zoom lens are a large size, a heavy weight, and a high cost.

It is preferable that the projection variable focus lens according to this embodiment satisfy at least one of the following Conditional expressions 1 and 2:

−2.5<f₁/f_{w}<−0.5; and [Conditional expression 1]

1.0<f₂/f_{w}<4.0 [Conditional expression 2]

(where f_{w} indicates the focal length of the entire system at the wide angle end, f₁ indicates the focal length of the first lens L₁, and f₂ indicates the focal length of the second lens L₂).

Next, the technical meaning of the above-mentioned Conditional expressions 1 and 2 will be described.

First, Conditional expression 1 defines the range of the ratio between the focal length f₁ of the first lens L₁ and the focal length f_{w} of the entire system at the wide angle end. In addition, Conditional expression 1 defines a range capable of effectively correcting aberrations and obtaining an appropriate back focal length.

That is, if the ratio is less than the lower limit of Conditional expression 1, the negative refractive power of the first lens L₁ is too weak, and the back focal length of the lens is small. Therefore, it is difficult to insert a color composition optical system, such as a color composition prism. On the other hand, if the ratio is more than the upper limit, the negative refractive power of the first lens is two strong and it is difficult to effectively correct off-axis aberrations, such as comatic aberration and field curvature. In addition, the back focal length of the lens increases, which results in an increase in the size of a lens system.

It is preferable that the projection variable focus lens according to this embodiment satisfy the following Conditional expression 1′ in order to more effectively obtain the effects of Conditional expression 1:

−2.2<f₁/f_{w}<−0.8. [Conditional expression 1′]

Conditional expression 2 defines the range of the ratio between the focal length f₂ of the second lens L₂ and the focal length f_{w} of the entire system at the wide angle end and also defines the range of the power of the second lens L₂.

That is, if the ratio is less than the lower limit of Conditional expression 2, the power of the third lens L₃ is too strong and it is difficult to correct aberrations. On the other hand, if the ratio is more than the upper limit, the amount of movement of the second lens L₂ is too large when power varies, and the overall length of the lens system increases.

It is preferable that the projection variable focus lens according to this embodiment satisfy the following Conditional expression 2′ in order to more effectively obtain the effects of Conditional expression 2:

1.2<f₂/f_{w}<3.4. [Conditional expression 2′]

It is preferable that the third lens L₃ be a positive lens having a convex surface facing the reduction side. When the third lens L₃ is a positive lens, it is possible to reduce longitudinal chromatic aberration such as spherical aberration.

It is preferable that the fourth lens L₄ be a negative lens, the fifth lens L₅ be a positive lens, and the sixth lens L₆ be a positive lens. In this case, it is possible to improve the telecentricity of the lens system on the reduction side.

In the projection variable focus lens according to each of the following examples, at least one surface of the first lens L₁ is an aspheric surface. In this way, it is possible to effectively correct distortion. When at least one surface of the first lens L₁ is an aspheric surface, it is possible to appropriately correct aberration at each angle of view. The shape of the aspheric surface is represented by the following aspheric expression:

$$Z = \frac{{Y}^{2} / R}{1 + \sqrt{1 - K \times {Y}^{2} / {R}^{2}}} + {\sum }_{i = 3}^{16} {A}_{i} {Y}^{i} \qquad [ Expression 1 ]$$

(where Z indicates the length of a perpendicular line that drops from a point on an aspheric surface at a distance Y from the optical axis to a tangent plane to the top of the aspheric surface (a plane vertical to the optical axis), Y indicates the distance from the optical axis, R indicates the curvature radius of an aspheric surface near the optical axis, K indicates eccentricity, and Aᵢ indicates an aspheric coefficient (i=3 to 16)).

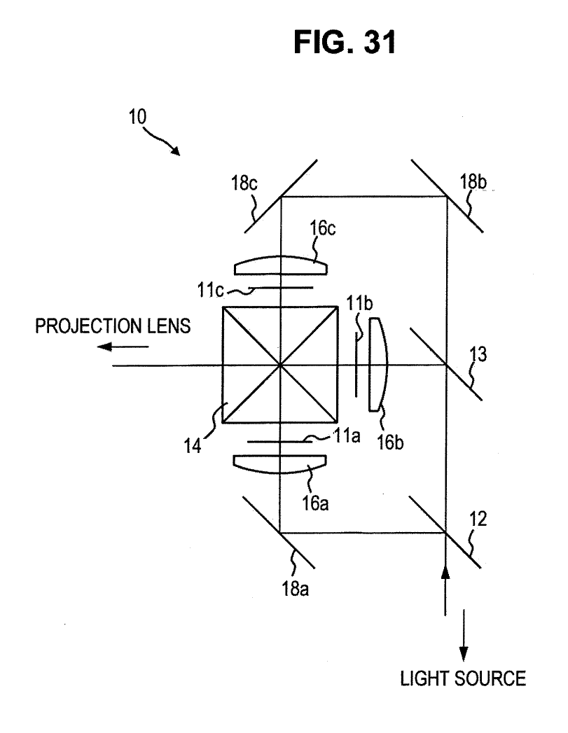

An example of a projection display device provided with the above-mentioned projection variable focus lens will be described with reference to FIG. 31. The projection display device shown in FIG. 31 includes transmissive liquid crystal panels 11a to 11c as light valves and uses the projection variable focus lens 10 according to the above-described embodiment as a projection variable focus lens. An integrator (not shown), such as a fly-eye lens, is provided between a light source and a dichroic mirror 12. White light emitted from the light source is incident on the liquid crystal panels 11a to 11c corresponding to three color light beams (G light, B light, and R light) through an illumination optical unit and then modulated. The modulated light components are composed by a cross dichroic prism 14, and the composed light is projected onto a screen (not shown) by the projection variable focus lens 10. This device includes the dichroic mirrors 12 and 13 for color separation, the cross dichroic prism 14 for color composition, condenser lenses 16a to 16c, and total reflecting mirrors 18a to 18c. In this embodiment, the projection display device uses the projection variable focus lens according to this embodiment. Therefore, the projection display device can have a high magnifying power, a small size, a light weight, and a low manufacturing cost. In addition, the projection display device can maintain a high optical performance.

The use of the projection variable focus lens according to this embodiment of the invention is not limited to the projection display device using a transmissive liquid crystal display panel, but the projection variable focus lens according to this embodiment may be used for a display device using a reflective liquid crystal display panel or another light modulating unit such as a DMD.

### EXAMPLES

Next, the projection variable focus lens will be described with reference to detailed examples.

### First Example Group

A first example group includes projection variable focus lenses according to the following Examples 1 to 6. Each of the projection variable focus lenses includes a first lens group G₁ including a first lens L₁, a second lens group G₂ including a second lens L₂ and a third lens L₃, and a third lens group G₃ including fourth to sixth lenses L₄ to L₆. When power varies, the first lens group G₁ and the second lens group G₂ are independently moved.

### Example 1

The projection variable focus lens according to Example 1 has the structure shown in FIG. 1.

That is, the projection variable focus lens includes the first to sixth lenses L₁ to L₆ of the first to third groups G₁ to G₃ arranged in this order from the magnification side. The first lens group G₁ includes the first lens L₁, which is a negative meniscus lens (on the axis) having aspheric surfaces at both sides, one of which is a concave surface facing the reduction side. The second lens group G₂ includes the second lens L₂, which is a biconvex lens, the mask 3 (an aperture diaphragm may be used instead of the mask: which is the same with the following examples), and the third lens L₃, which is a positive meniscus lens (on the axis) having aspheric surfaces at both sides, one of which is a convex surface facing the reduction side. The third lens group G₃ includes the fourth lens L₄, which is a biconcave lens, the fifth lens L₅, which is a positive meniscus lens having a convex surface facing the reduction side, and the sixth lens L₆, which is a planoconvex lens having a flat surface facing the reduction side.

When power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 1, an upper part shows the curvature radius R of each lens surface according to Example 1 (the focal length of the entire lens system at the wide angle end is normalized to 1.00, which is the same with the following tables), the thickness of the center of each lens and an air space D between the lenses (which are normalized, similar to the curvature radius R, which is the same with the following tables), and the refractive index Nd and the Abbe number νd of each lens with respect to the d-line. In Table 1 and Tables 2 to 15, which will be described below, numbers corresponding to R, D, Nd, and νd are sequentially increased from the magnification side.

In Table 1, a middle part shows a variable spacing 1 (the gap between the first lens group G₁ and the second lens group G₂: movement 1 (which is the same with the following tables)) and a variable spacing 2 (the gap between the second lens group G₂ and the third lens group G₃: movement 2 (which is the same with the following tables)) at the wide angle end (wide), a middle position (middle), and the telephoto end (tele). In Table 1, a lower part shows the values of constants K and A₃ to A₁₆ corresponding to the aspheric surfaces.

TABLE 1
Focal length F = 1.00~1.06~1.10

| Surface | R | D | Nd | νd |
|---|---|---|---|---|
| 1* | 3.005 | 0.157 | 1.4910 | 57.6 |
| 2* | 0.621 | (Movement 1) | | |
| 3 | 2.643 | 0.166 | 1.7130 | 53.9 |
| 4 | −4.264 | 1.433 | | |
| 5 (Mask) | ∞ | 0.157 | | |
| 6* | −2.537 | 0.325 | 1.4910 | 57.6 |
| 7* | −0.866 | (Movement 2) | | |
| 8 | −1.269 | 0.060 | 1.8052 | 25.4 |
| 9 | 5.847 | 0.069 | | |
| 10 | −4.080 | 0.365 | 1.5891 | 61.1 |
| 11 | −1.221 | 0.005 | | |
| 12 | 1.534 | 0.277 | 1.6031 | 60.6 |
| 13 | ∞ | 0.616 | | |
| 14 | ∞ | 1.363 | 1.5163 | 64.1 |
| 15 | ∞ | | | |

| | Wide | Middle | Telephoto |
|---|---|---|---|
| Movement spacing | angle end | position | end |
| Movement 1 | 1.966 | 1.788 | 1.681 |
| Movement 2 | 0.084 | 0.163 | 0.215 |

Aspheric coefficient

| Surface number | K | A₃ | A₄ | A₅ | A₆ |
|---|---|---|---|---|---|
| 1 | 10.21390 | −3.09232E−01 | 1.58125E+00 | −3.23517E+00 | 1.86482E+00 |
| | A₇ | A₈ | A₉ | A₁₀ | A₁₁ |
| | 1.07584E+00 | 2.75191E−01 | −2.66275E+00 | 3.18110E−01 | −3.17006E+00 |
| | A₁₂ | A₁₃ | A₁₄ | A₁₅ | A₁₆ |
| | 6.09307E+00 | 1.50239E+01 | −4.17784E+01 | 3.55517E+01 | −1.09120E+01 |
| | K | A₃ | A₄ | A₅ | A₆ |
| 2 | 0.59492 | −2.98881E−01 | 1.34313E+00 | −1.52524E+00 | −4.11465E+00 |
| | A₇ | A₈ | A₉ | A₁₀ | A₁₁ |
| | 7.09570E+00 | 2.79191E+00 | −5.84304E+00 | −9.57354E+00 | 8.91762E+00 |
| | A₁₂ | A₁₃ | A₁₄ | A₁₅ | A₁₆ |
| | −1.86546E+01 | 4.24958E+01 | −4.14328E+01 | 7.02772E+01 | −6.36704E+01 |
| | K | A₃ | A₄ | A₅ | A₆ |
| 6 | 1.00000 | 0.00000E+00 | −3.35745E−01 | −6.23109E−01 | 2.99994E+00 |
| | A₇ | A₈ | A₉ | A₁₀ | |
| | −8.93883E+00 | −5.69173E+00 | 5.55721E+01 | −7.09257E+01 | |
| | K | A₃ | A₄ | A₅ | A₆ |
| 7 | 1.00000 | 0.00000E+00 | −1.16954E−01 | 2.85364E−01 | −7.42658E−01 |
| | A₇ | A₈ | A₉ | A₁₀ | |
| | −1.49829E+00 | 2.23928E+00 | 6.05298E+00 | −1.35209E+01 | |

*Aspheric surface

In addition, Table 16 shows numerical values corresponding to the conditional expressions according to Example 1.

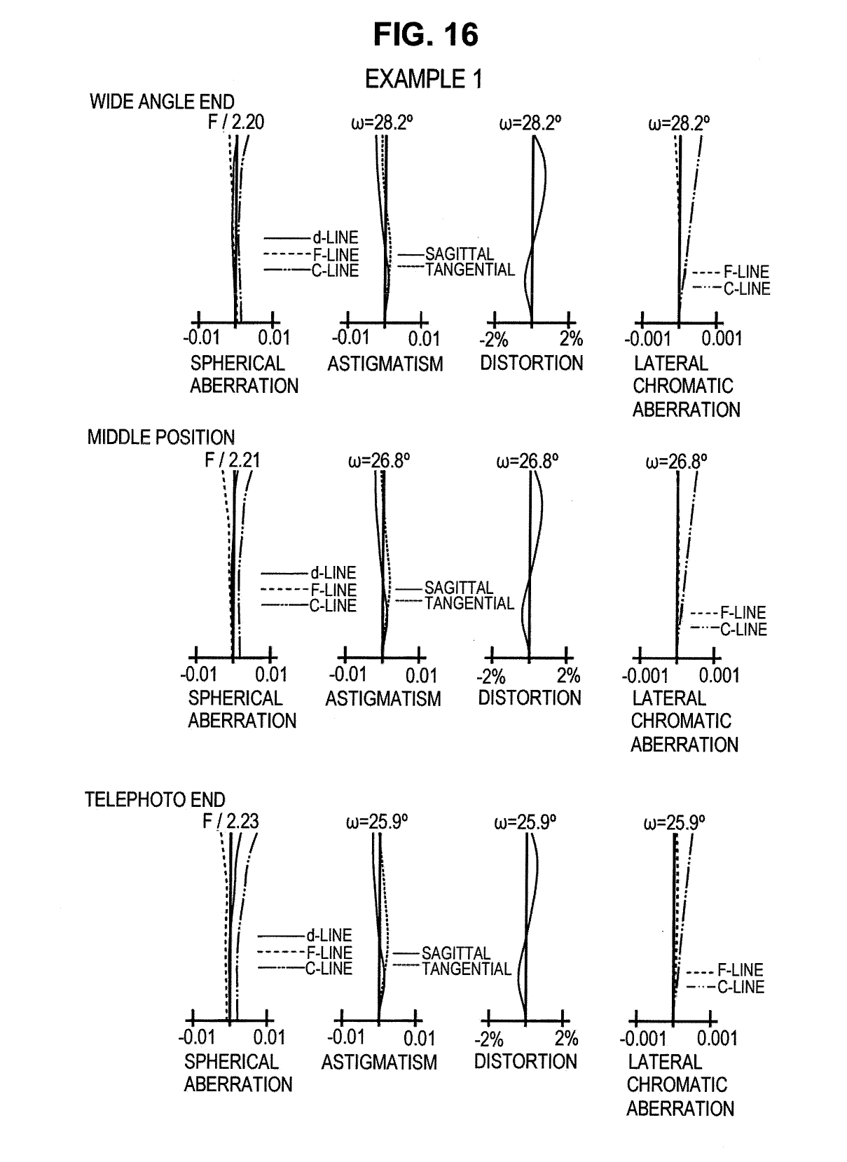

FIG. 16 is an aberration diagram illustrating all aberrations (spherical aberration, astigmatism, distortion, and lateral chromatic aberration) of the projection variable focus lens according to Example 1 at the wide angle end (wide), the middle position (middle), and the telephoto end (tele). FIG. 16 and FIGS. 17 to 30 show the spherical aberration of the lens with respect to the d-line, the F-line, and C-line, the astigmatism of the lens with respect to a sagittal image surface and a tangential image surface, and the lateral chromatic aberration of the lens with respect to the F-line and the C-line.

As can be seen from FIG. 16, the projection variable focus lens according to Example 1 has an angle of view 2ω of 56.4 degrees, which is a wide angle, and an F number of 2.20, which is a large value, at the wide angle end. Therefore, all aberrations are effectively corrected.

In addition, as shown in Table 16, the projection variable focus lens according to Example 1 satisfies all of Conditional expressions 1 and 2 and Conditional expressions 1′ and 2′.

### Example 2

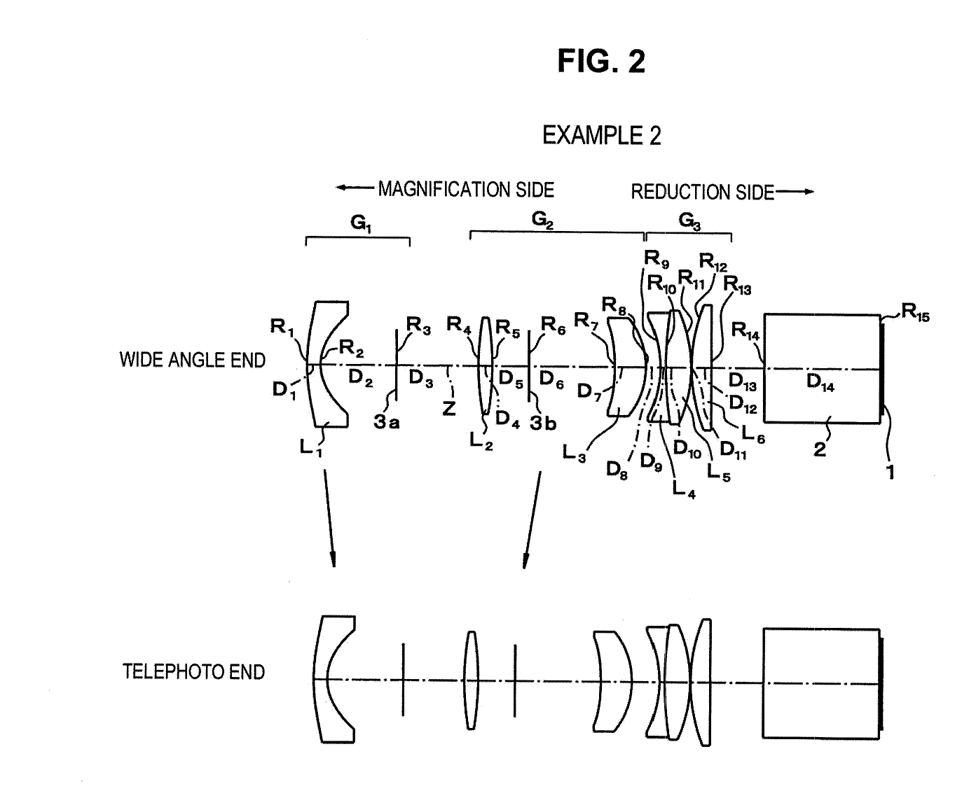

The projection variable focus lens according to Example 2 has the structure shown in FIG. 2.

That is, the projection variable focus lens has substantially the same structure as that according to Example 1 except that a mask 3a is provided in the first lens group G₁, a mask 3b is provided in the second lens group G₂, and the fourth lens L₄ and the fifth lens L₅ are bonded to form a cemented lens.

Similar to Example 1, when power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 2, an upper part shows the curvature radius R of each lens surface according to Example 2, the thickness of the center of each lens and the air space D between the lenses, and the refractive index Nd and the Abbe number νd of each lens with respect to the d-line.

In Table 2, a middle part shows the variable spacing 1 and the variable spacing 2 at the wide angle end (wide), the middle position (middle), and the telephoto end (tele). In Table 2, a lower part shows the values of the constants K and A₃ to A₁₆ corresponding to the aspheric surfaces.

TABLE 2
Focal length F = 1.00~1.06~1.10

| Surface | R | D | Nd | νd |
|---|---|---|---|---|
| 1* | 1.993 | 0.157 | 1.4910 | 57.6 |
| 2* | 0.548 | 0.892 | | |
| 3 (Mask) | ∞ | (Movement 1) | | |
| 4 | 3.220 | 0.163 | 1.7100 | 54.6 |
| 5 | −3.421 | 0.409 | | |
| 6 (Mask) | ∞ | 1.033 | | |
| 7* | −2.159 | 0.367 | 1.4910 | 57.6 |
| 8* | −0.920 | (Movement 2) | | |
| 9 | −1.274 | 0.060 | 1.7688 | 27.4 |
| 10 | 4.173 | 0.298 | 1.6303 | 60.0 |
| 11 | −1.606 | 0.005 | | |
| 12 | 1.949 | 0.230 | 1.6389 | 59.6 |
| 13 | ∞ | 0.616 | | |
| 14 | ∞ | 1.364 | 1.5163 | 64.1 |
| 15 | ∞ | | | |

| | Wide | Middle | Telephoto |
|---|---|---|---|
| Movement spacing | angle end | position | end |
| Movement 1 | 0.968 | 0.815 | 0.722 |
| Movement 2 | 0.166 | 0.258 | 0.319 |

Aspheric coefficient

| Surface number | K | A₃ | A₄ | A₅ | A₆ |
|---|---|---|---|---|---|
| 1 | −19.81103 | −2.30006E−01 | 1.56438E+00 | −3.16029E+00 | 1.89003E+00 |
| | A₇ | A₈ | A₉ | A₁₀ | A₁₁ |
| | 1.02184E+00 | 2.62551E−01 | −2.59522E+00 | 3.56318E−01 | −3.16470E+00 |
| | A₁₂ | A₁₃ | A₁₄ | A₁₅ | A₁₆ |
| | 5.98007E+00 | 1.48350E+01 | −4.13280E+01 | 3.57176E+01 | −1.12451E+01 |
| | K | A₃ | A₄ | A₅ | A₆ |
| 2 | 0.39088 | −2.08862E−01 | 9.80225E−01 | −1.06420E+00 | −4.75380E+00 |
| | A₇ | A₈ | A₉ | A₁₀ | A₁₁ |
| | 7.69689E+00 | 4.34305E+00 | −5.69216E+00 | −1.26525E+01 | 3.49791E+00 |
| | A₁₂ | A₁₃ | A₁₄ | A₁₅ | A₁₆ |
| | −2.11960E+01 | 4.77214E+01 | −2.24480E+01 | 1.27206E+02 | −1.55429E+02 |
| | K | A₃ | A₄ | A₅ | A₆ |
| 7 | 1.00000 | 0.00000E+00 | −8.58036E−03 | −1.40799E+00 | 4.63517E+00 |
| | A₇ | A₈ | A₉ | A₁₀ | |
| | −5.28262E+00 | −1.15847E+01 | 3.49555E+01 | −2.71626E+01 | |
| | K | A₃ | A₄ | A₅ | A₆ |
| 8 | 1.00000 | 0.00000E+00 | 5.11912E−02 | −1.40776E−01 | 3.73529E−01 |
| | A₇ | A₈ | A₉ | A₁₀ | |
| | −8.37957E−01 | 2.82206E−01 | 1.41395E+00 | −2.19535E+00 | |

*Aspheric surface

In addition, Table 16 shows numerical values corresponding to the conditional expressions according to Example 2.

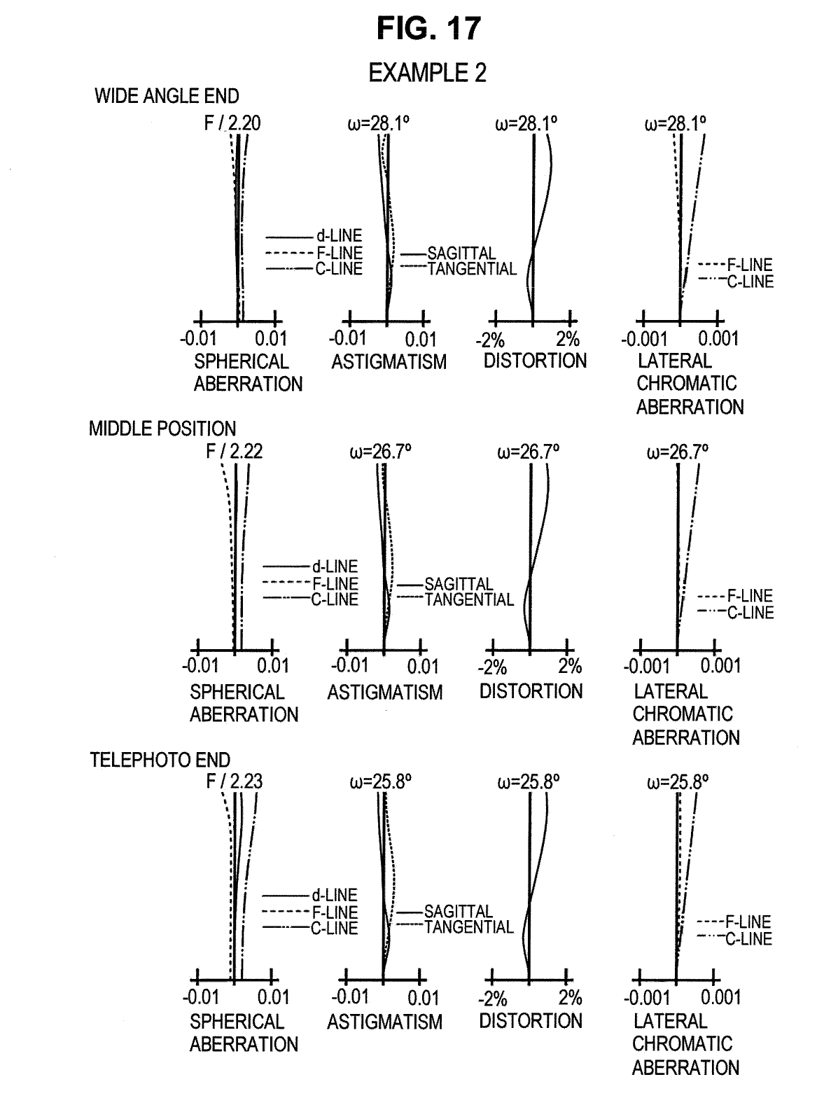

FIG. 17 is an aberration diagram illustrating all aberrations (spherical aberration, astigmatism, distortion, and lateral chromatic aberration) of the projection variable focus lens according to Example 2 at the wide angle end (wide), the middle position (middle), and the telephoto end (tele).

As can be seen from FIG. 17, the projection variable focus lens according to Example 2 has an angle of view 2ω of 56.2 degrees, which is a wide angle, and an F number of 2.20, which is a large value, at the wide angle end. Therefore, all aberrations are effectively corrected.

In addition, as shown in Table 16, the projection variable focus lens according to Example 2 satisfies all of Conditional expressions 1 and 2 and Conditional expressions 1′ and 2′.

### Example 3

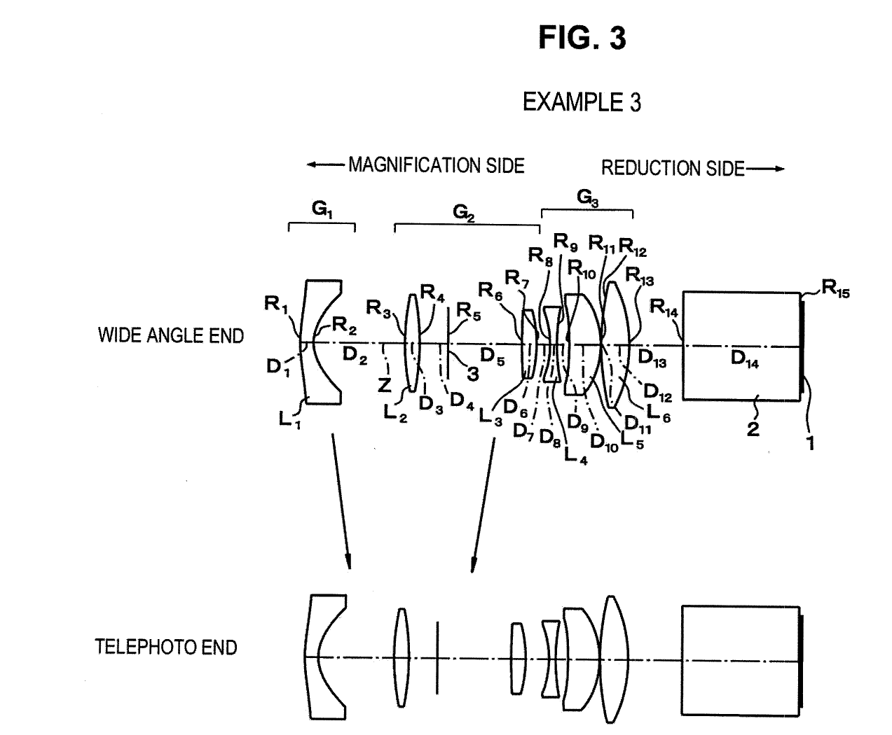

The projection variable focus lens according to Example 3 has the structure shown in FIG. 3.

That is, the projection variable focus lens has substantially the same structure as that according to Example 1 except that the third lens L₃ is a spherical biconvex lens, the fifth lens L₅ is a positive meniscus lens (on the axis) having aspheric surfaces at both sides, one of which is a convex surface facing the reduction, and the sixth lens L₆ is a biconvex lens.

Similar to Example 1, when power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 3, an upper part shows the curvature radius R of each lens surface according to Example 3, the thickness of the center of each lens and the air space D between the lenses, and the refractive index Nd and the Abbe number νd of each lens with respect to the d-line.

In Table 3, a middle part shows the variable spacing 1 and the variable spacing 2 at the wide angle end (wide), the middle position (middle), and the telephoto end (tele). In Table 3, a lower part shows the values of the constants K and A₃ to A₁₆ corresponding to the aspheric surfaces.

TABLE 3
Focal length F = 1.00~1.06~1.10

| Surface | R | D | Nd | νd |
|---|---|---|---|---|
| 1* | 1.409 | 0.157 | 1.4910 | 57.6 |
| 2* | 0.454 | (Movement 1) | | |
| 3 | 2.735 | 0.173 | 1.7100 | 39.0 |
| 4 | −2.944 | 0.331 | | |
| 5 (Mask) | ∞ | 0.864 | | |
| 6 | 6.965 | 0.171 | 1.6400 | 59.5 |
| 7 | −1.531 | (Movement 2) | | |
| 8 | −1.107 | 0.079 | 1.8000 | 25.0 |
| 9 | 2.327 | 0.145 | | |
| 10* | −3.667 | 0.367 | 1.4910 | 57.6 |
| 11* | −1.009 | 0.005 | | |
| 12 | 3.104 | 0.331 | 1.6400 | 59.5 |
| 13 | −1.637 | 0.616 | | |
| 14 | ∞ | 1.364 | 1.5163 | 64.1 |
| 15 | ∞ | | | |

| | Wide | Middle | Telephoto |
|---|---|---|---|
| Movement spacing | angle end | position | end |
| Movement 1 | 1.066 | 0.952 | 0.884 |
| Movement 2 | 0.157 | 0.225 | 0.269 |

Aspheric coefficient

| Surface number | K | A₃ | A₄ | A₅ | A₆ |
|---|---|---|---|---|---|
| 1 | −26.87387 | −1.07565E−01 | 8.06801E−01 | −2.66356E+00 | 2.56535E+00 |
| | A₇ | A₈ | A₉ | A₁₀ | A₁₁ |
| | 8.30469E−01 | −4.42345E−01 | −3.05166E+00 | 5.77832E−01 | −2.40790E+00 |
| | A₁₂ | A₁₃ | A₁₄ | A₁₅ | A₁₆ |
| | 6.66361E+00 | 1.48011E+01 | −4.22779E+01 | 3.46290E+01 | −1.01042E+01 |
| | K | A₃ | A₄ | A₅ | A₆ |
| 2 | 0.37381 | −6.78988E−02 | −1.51737E+00 | 2.49132E+00 | −5.48684E+00 |
| | A₇ | A₈ | A₉ | A₁₀ | A₁₁ |
| | 5.29503E+00 | 3.84856E+00 | −4.31393E+00 | −1.18226E+01 | 1.86745E+00 |
| | A₁₂ | A₁₃ | A₁₄ | A₁₅ | A₁₆ |
| | −2.34569E+01 | 4.94706E+01 | −1.40395E+01 | 1.32051E+02 | −1.85394E+02 |
| | K | A₃ | A₄ | A₅ | A₆ |
| 10 | 1.00000 | 0.00000E+00 | −1.01736E−02 | −1.86630E+00 | 4.89119E+00 |
| | A₇ | A₈ | A₉ | A₁₀ | |
| | −3.78377E+00 | −1.09018E+01 | 2.11231E+01 | −1.14763E+01 | |
| | K | A₃ | A₄ | A₅ | A₆ |
| 11 | 1.00000 | 0.00000E+00 | −1.79412E−02 | −4.47250E−02 | −3.46915E−01 |
| | A₇ | A₈ | A₉ | A₁₀ | |
| | 2.77308E−01 | 2.32510E−01 | −4.10786E−01 | −1.13889E+00 | |

*Aspheric surface

In addition, Table 16 shows numerical values corresponding to the conditional expressions according to Example 3.

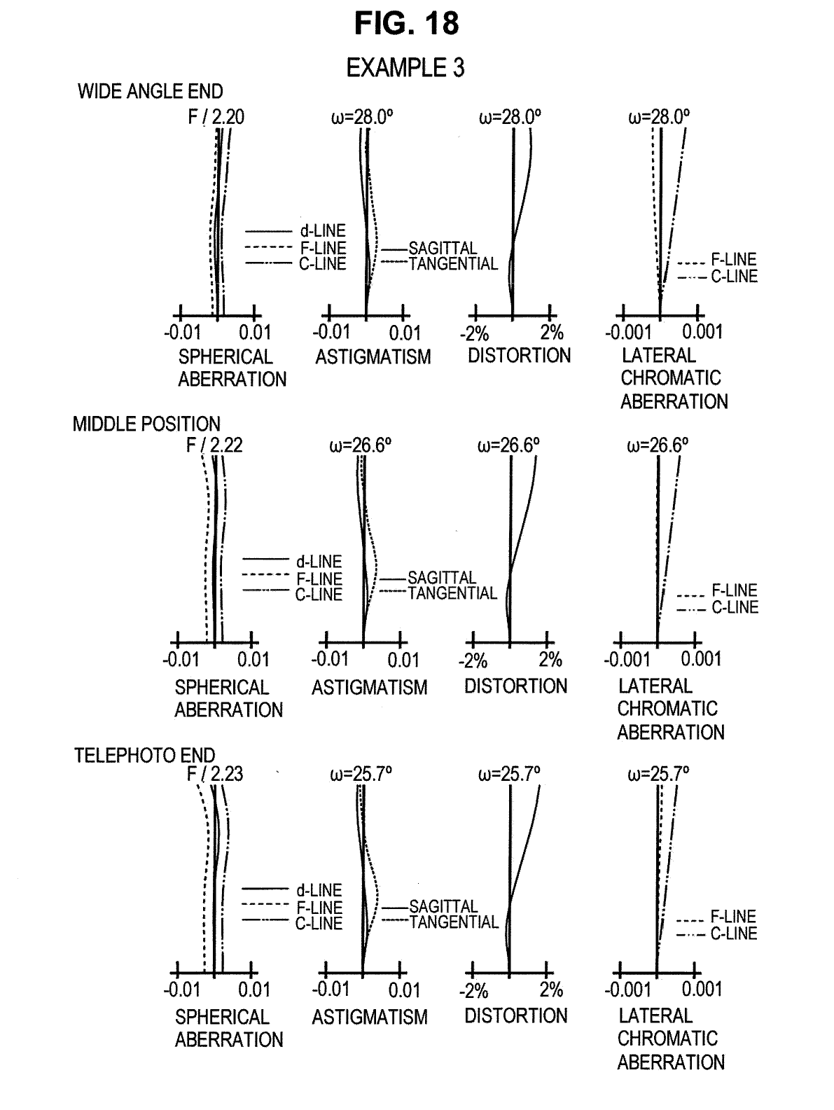

FIG. 18 is an aberration diagram illustrating all aberrations (spherical aberration, astigmatism, distortion, and lateral chromatic aberration) of the projection variable focus lens according to Example 3 at the wide angle end (wide), the middle position (middle), and the telephoto end (tele).

As can be seen from FIG. 18, the projection variable focus lens according to Example 3 has an angle of view 2ω of 56.0 degrees, which is a wide angle, and an F number of 2.20, which is a large value, at the wide angle end. Therefore, all aberrations are effectively corrected.

In addition, as shown in Table 16, the projection variable focus lens according to Example 3 satisfies all of Conditional expressions 1 and 2 and Conditional expressions 1′ and 2′.

### Example 4

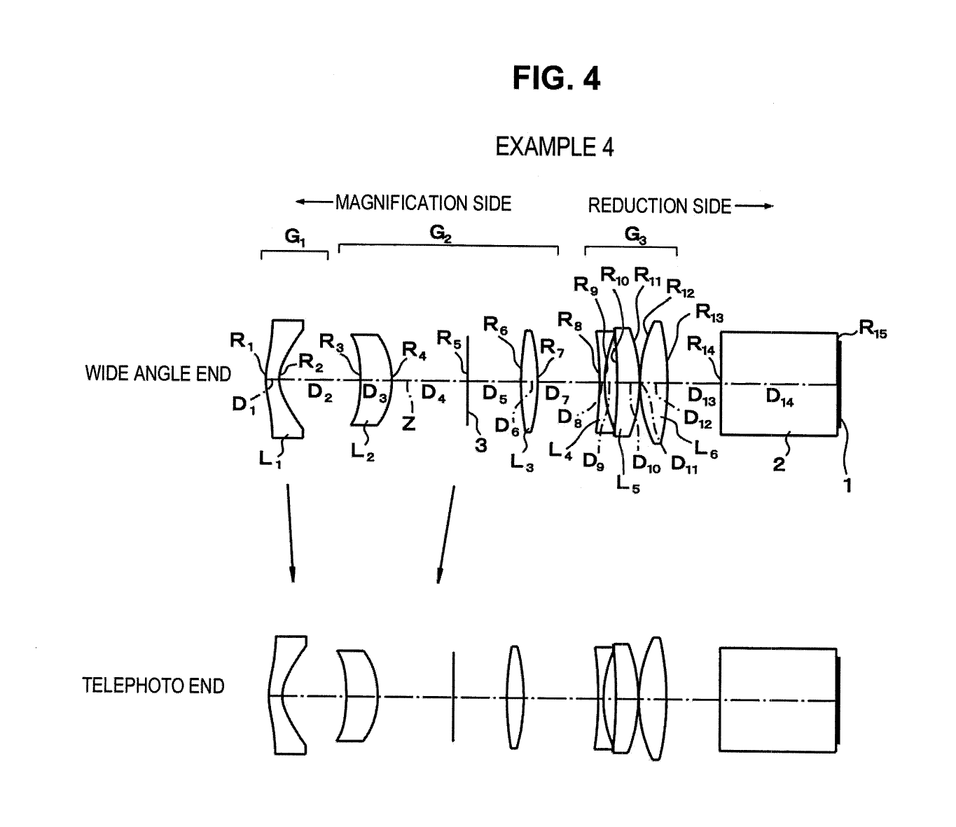

The projection variable focus lens according to Example 4 has the structure shown in FIG. 4.

That is, the projection variable focus lens has substantially the same structure as that according to Example 1 except that the second lens L₂ is a positive meniscus lens (on the axis) having aspheric surfaces at both sides, one of which is a convex surface facing the reduction side, the third lens L₃ is a spherical biconvex lens, and the sixth lens L₆ is a biconvex lens.

Similar to Example 1, when power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 4, an upper part shows the curvature radius R of each lens surface according to Example 4, the thickness of the center of each lens and the air space D between the lenses, and the refractive index Nd and the Abbe number νd of each lens with respect to the d-line.

In Table 4, a middle part shows the variable spacing 1 and the variable spacing 2 at the wide angle end (wide), the middle position (middle), and the telephoto end (tele). In Table 4, a lower part shows the values of the constants K and A₃ to A₁₆ corresponding to the aspheric surfaces.

TABLE 4
Focal length F = 1.00~1.06~1.10

| Surface | R | D | Nd | νd |
|---|---|---|---|---|
| 1* | 0.623 | 0.124 | 1.4910 | 57.6 |
| 2* | 0.300 | (Movement 1) | | |
| 3* | −1.825 | 0.290 | 1.4910 | 57.6 |
| 4* | −0.781 | 0.708 | | |
| 5 (Mask) | ∞ | 0.494 | | |
| 6 | 2.628 | 0.156 | 1.5891 | 61.1 |
| 7 | −1.808 | (Movement 2) | | |
| 8 | −3.438 | 0.048 | 1.8052 | 25.4 |
| 9 | 1.089 | 0.111 | | |
| 10 | −4.317 | 0.207 | 1.5891 | 61.1 |
| 11 | −1.360 | 0.004 | | |
| 12 | 1.285 | 0.255 | 1.5891 | 61.1 |
| 13 | −2.473 | 0.486 | | |
| 14 | ∞ | 1.079 | 1.5163 | 64.1 |
| 15 | ∞ | | | |

| | Wide | Middle | Telephoto |
|---|---|---|---|
| Movement spacing | angle end | position | end |
| Movement 1 | 0.750 | 0.651 | 0.591 |
| Movement 2 | 0.574 | 0.645 | 0.692 |

Aspheric coefficient

| Surface number | K | A₃ | A₄ | A₅ | A₆ |
|---|---|---|---|---|---|
| 1 | −5.43049 | −7.14264E−02 | −1.68889E+00 | −3.54912E+00 | 1.28173E+01 |
| | A₇ | A₈ | A₉ | A₁₀ | A₁₁ |
| | 5.30567E+00 | −6.43911E+00 | −3.26422E+01 | −1.79962E+01 | −5.42849E+01 |
| | A₁₂ | A₁₃ | HD 14 | A₁₅ | A₁₆ |
| | 8.55727E+01 | 3.76781E+02 | −4.59914E+02 | 1.49225E+03 | −2.25449E+03 |
| | K | A₃ | A₄ | A₅ | A₆ |
| 2 | −0.52967 | −9.72314E−03 | −5.02081E+00 | 8.03372E+00 | −3.90700E+00 |
| | A₇ | A₈ | A₉ | A₁₀ | A₁₁ |
| | 2.50325E+01 | 5.79256E+00 | −5.89183E+01 | −1.64813E+02 | −9.94991E+01 |
| | A₁₂ | A₁₃ | HD 14 | A₁₅ | A₁₆ |
| | −3.26537E+02 | 1.59970E+03 | 2.47288E+03 | 7.01701E+03 | −2.12448E+04 |
| | K | A₃ | A₄ | A₅ | A₆ |
| 3 | 1.00000 | 0.00000E+00 | −6.40068E−01 | −2.84949E+00 | 1.27332E+01 |
| | A₇ | A₈ | A₉ | A₁₀ | |
| | −3.21700E+01 | −3.11506E+01 | 2.64084E+02 | −3.53279E+02 | |
| | K | A₃ | A₄ | A₅ | A₆ |
| 4 | 1.00000 | 0.00000E+00 | −2.28944E−01 | −1.74180E−01 | −4.44225E+00 |
| | A₇ | A₈ | A₉ | A₁₀ | |
| | 1.26994E+01 | 6.87919E+00 | −7.28298E+01 | 6.45155E+01 | |

*Aspheric surface

In addition, Table 16 shows numerical values corresponding to the conditional expressions according to Example 4.

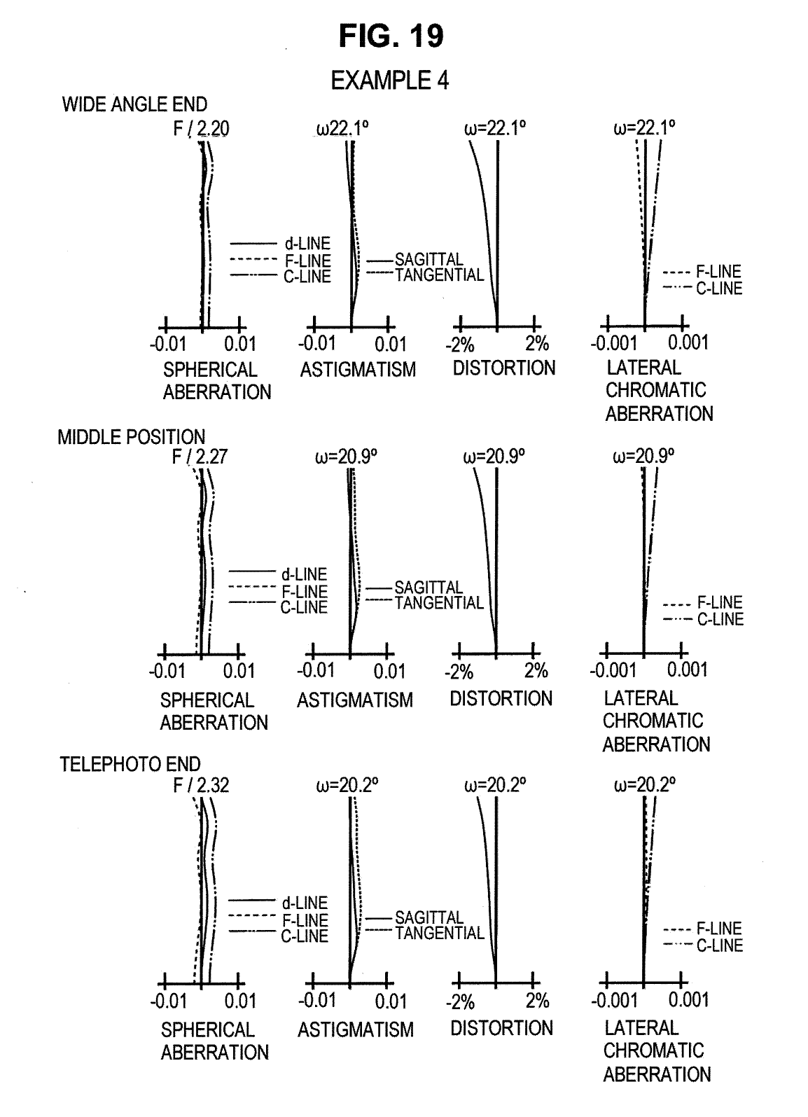

FIG. 19 is an aberration diagram illustrating all aberrations (spherical aberration, astigmatism, distortion, and lateral chromatic aberration) of the projection variable focus lens according to Example 4 at the wide angle end (wide), the middle position (middle), and the telephoto end (tele).

As can be seen from FIG. 19, the projection variable focus lens according to Example 4 has an angle of view 2w of 44.2 degrees, which is a wide angle, and an F number of 2.20, which is a large value, at the wide angle end. Therefore, all aberrations are effectively corrected.

In addition, as shown in Table 16, the projection variable focus lens according to Example 4 satisfies all of Conditional expressions 1 and 2 and Conditional expressions 1′ and 2′.

### Example 5

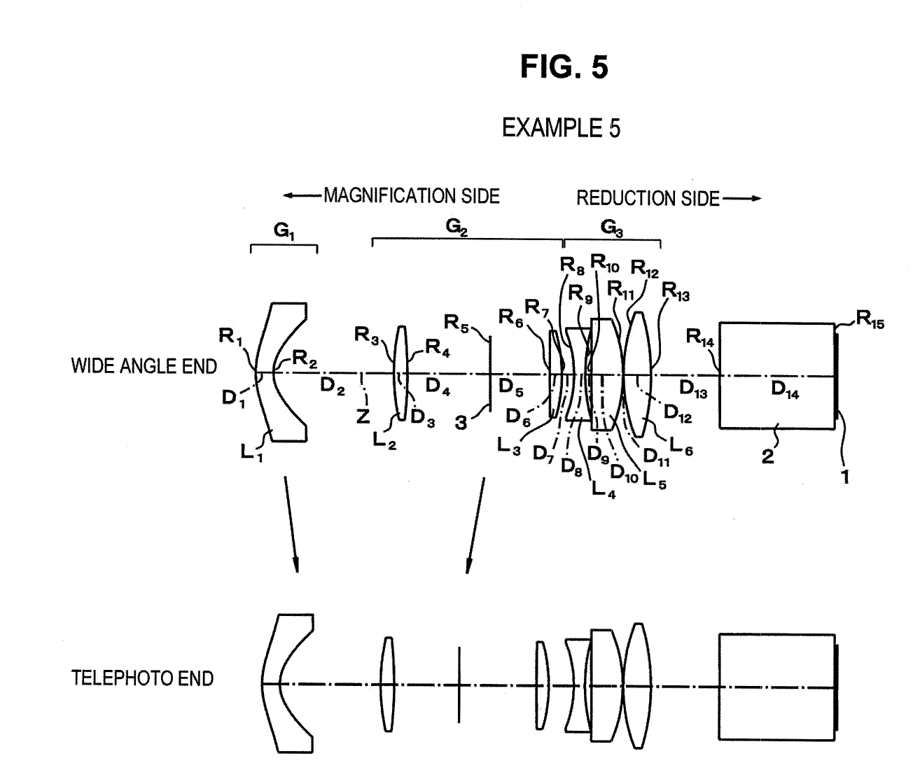

The projection variable focus lens according to Example 5 has the structure shown in FIG. 5.

That is, the projection variable focus lens has substantially the same structure as that according to Example 1 except that the third lens L₃ is a spherical biconvex lens, the fifth lens L₅ is a planoconvex lens having a convex surface facing the reduction side, and the sixth lens L₆ is a biconvex lens.

Similar to Example 1, when power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 5, an upper part shows the curvature radius R of each lens surface according to Example 5, the thickness of the center of each lens and the air space D between the lenses, and the refractive index Nd and the Abbe number νd of each lens with respect to the d-line.

In Table 5, a middle part shows the variable spacing 1 and the variable spacing 2 at the wide angle end (wide), the middle position (middle), and the telephoto end (tele). In Table 5, a lower part shows the values of the constants K and A₃ to A₁₆ corresponding to the aspheric surfaces.

TABLE 5
Focal length F = 1.00~1.06~1.10

| Surface | R | D | Nd | νd |
|---|---|---|---|---|
| 1* | 0.697 | 0.166 | 1.4910 | 57.6 |
| 2* | 0.333 | (Movement 1) | | |
| 3 | 1.948 | 0.127 | 1.6700 | 47.2 |
| 4 | −3.862 | 0.776 | | |
| 5 (Mask) | ∞ | 0.553 | | |
| 6 | 21.748 | 0.116 | 1.6385 | 55.4 |
| 7 | −1.440 | (Movement 2) | | |
| 8 | −1.058 | 0.103 | 1.7552 | 27.5 |
| 9 | 1.611 | 0.058 | | |
| 10 | ∞ | 0.290 | 1.5891 | 61.1 |
| 11 | −1.285 | 0.004 | | |
| 12 | 1.592 | 0.257 | 1.6385 | 55.4 |
| 13 | −2.041 | 0.635 | | |
| 14 | ∞ | 1.077 | 1.5163 | 64.1 |
| 15 | ∞ | | | |

| | Wide | Middle | Telephoto |
|---|---|---|---|
| Movement spacing | angle end | position | end |
| Movement 1 | 1.125 | 1.009 | 0.939 |
| Movement 2 | 0.115 | 0.188 | 0.236 |

Aspheric coefficient

| Surface number | K | A₃ | A₄ | A₅ | A₆ |
|---|---|---|---|---|---|
| 1 | −7.19288 | 1.41448E−01 | 4.87616E−01 | −2.33598E+00 | 9.72406E−01 |
| | A₇ | A₈ | A₉ | A₁₀ | A₁₁ |
| | −2.10911E−01 | 5.41696E+00 | −4.82268E+00 | 1.49003E+01 | −4.31775E+01 |
| | A₁₂ | A₁₃ | HD 14 | A₁₅ | A₁₆ |
| | 2.90785E+01 | 1.86866E+02 | −8.39854E+02 | 1.30441E+03 | −6.86505E+02 |
| | K | A₃ | A₄ | A₅ | A₆ |
| 2 | 0.00011 | 2.86908E−01 | −4.34587E+00 | 8.93839E+00 | −4.99535E+00 |
| | A₇ | A₈ | A₉ | A₁₀ | A₁₁ |
| | −9.84456E+00 | −1.72058E+01 | 4.17037E+01 | 1.19840E+02 | 1.65719E+02 |
| | A₁₂ | A₁₃ | HD 14 | A₁₅ | A₁₆ |
| | −7.78333E+02 | −4.88447E+02 | −8.96426E+02 | 7.96452E+03 | −6.95944E+03 |

*Aspheric surface

In addition, Table 16 shows numerical values corresponding to the conditional expressions according to Example 5.

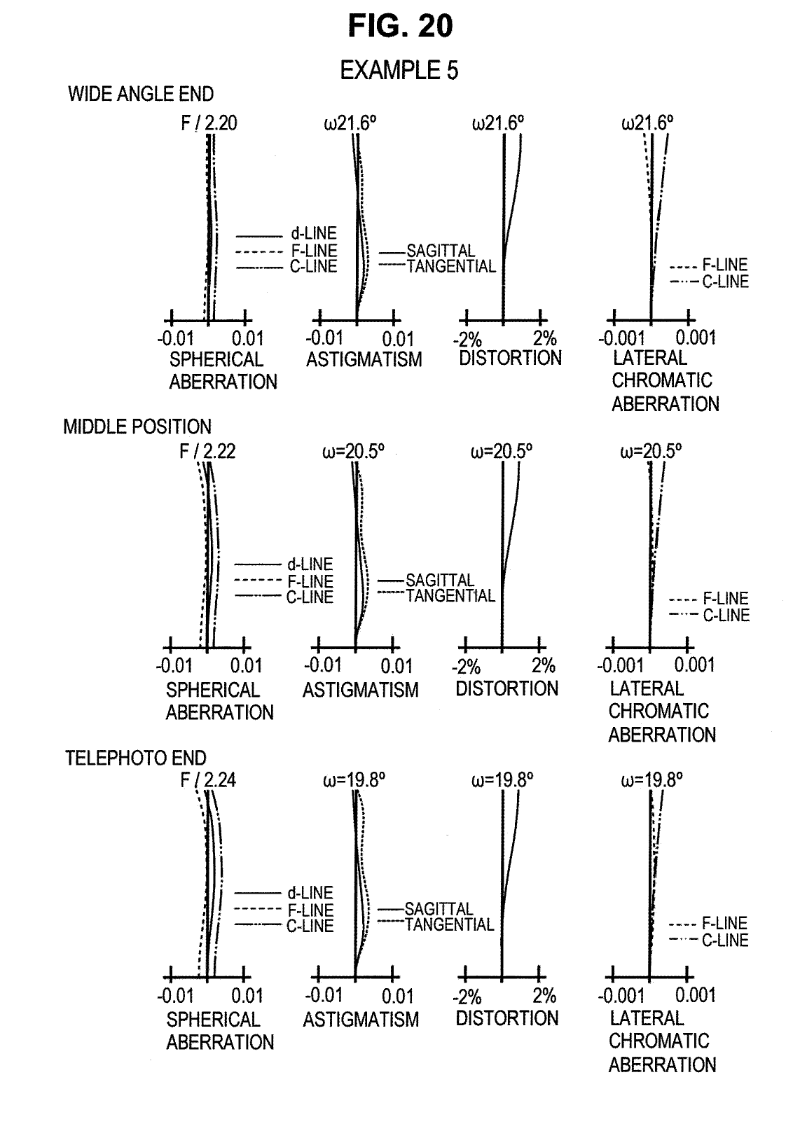

FIG. 20 is an aberration diagram illustrating all aberrations (spherical aberration, astigmatism, distortion, and lateral chromatic aberration) of the projection variable focus lens according to Example 5 at the wide angle end (wide), the middle position (middle), and the telephoto end (tele).

As can be seen from FIG. 20, the projection variable focus lens according to Example 5 has an angle of view 2w of 43.2 degrees, which is a wide angle, and an F number of 2.20, which is a large value, at the wide angle end. Therefore, all aberrations are effectively corrected.

In addition, as shown in Table 16, the projection variable focus lens according to Example 5 satisfies all of Conditional expressions 1 and 2 and Conditional expressions 1′ and 2′.

### Example 6

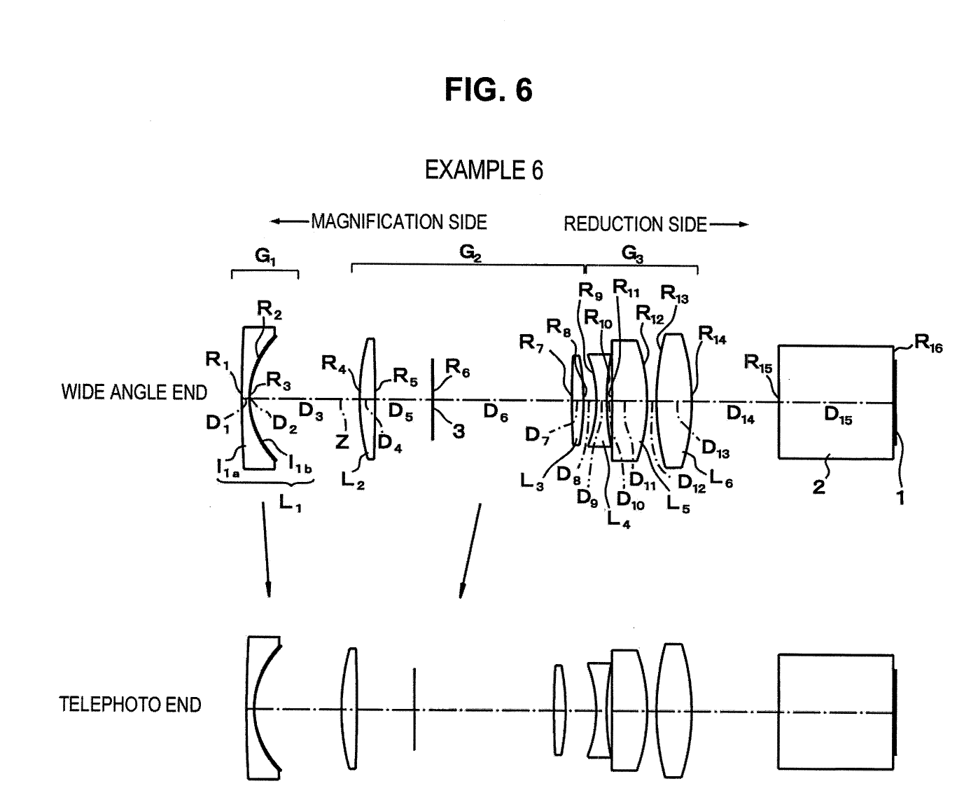

The projection variable focus lens according to Example 6 has the structure shown in FIG. 6.

That is, the projection variable focus lens has substantially the same structure as that according to Example 1 except that the first lens L₁ is a composite aspheric lens (in which a resin film is provided on a reduction-side surface of a glass lens and the surface of the glass lens closest to the reduction side is an aspheric surface, which is the same as that in the first lens L₁ according to Example 13)) having a negative meniscus shape in which a concave surface faces the reduction side, the third lens L₃ is a biconvex lens, and the sixth lens L₆ is a biconvex lens.

Similar to Example 1, when power varies from the wide angle end to the telephoto end, the first lens group G₁ is moved to the reduction side along the optical axis Z and the second lens group G₂ is moved to the magnification side along the optical axis Z.

Focusing is performed by moving the first lens group G₁ in the direction of the optical axis Z (varifocal lens type).

In Table 6, an upper part shows the curvature radius R of each lens surface according to Example 6, the thickness of the center of each lens and the air space D between the lenses, and the refractive index Nd and the Abbe number νd of each lens with respect to the d-line.

In Table 6, a middle part shows the variable spacing 1 and the variable spacing 2 at the wide angle end (wide), the middle position (middle), and the telephoto end (tele). In Table 6, a lower part shows the values of the constants K and A₃ to A₁₆ corresponding to the aspheric surfaces.

TABLE 6
Focal length F = 1.00~1.06~1.10

| Surface | R | D | Nd | νd |
|---|---|---|---|---|
| 1 | 11.413 | 0.071 | 1.4875 | 70.2 |
| 2 | 0.826 | 0.004 | 1.5277 | 41.9 |
| 3* | 0.699 | (Movement 1) | | |
| 4 | 2.065 | 0.146 | 1.8040 | 46.6 |
| 5 | −15.428 | 0.538 | | |
| 6 (Mask) | ∞ | 1.305 | | |
| 7 | 7.712 | 0.111 | 1.7880 | 47.4 |
| 8 | −2.164 | (Movement 2) | | |
| 9 | −1.132 | 0.096 | 1.7847 | 26.3 |
| 10 | 2.216 | 0.052 | | |
| 11 | −54.554 | 0.331 | 1.7292 | 54.7 |
| 12 | −1.675 | 0.086 | | |
| 13 | 2.382 | 0.332 | 1.7292 | 54.7 |
| 14 | −2.087 | 0.817 | | |
| 15 | ∞ | 1.076 | 1.5163 | 64.1 |
| 16 | ∞ | | | |

| | Wide | Middle | Telephoto |
|---|---|---|---|
| Movement spacing | angle end | position | end |
| Movement 1 | 1.030 | 0.896 | 0.816 |
| Movement 2 | 0.123 | 0.223 | 0.290 |

Aspheric coefficient

| Surface number | K | A₃ | A₄ | A₅ | A₆ |
|---|---|---|---|---|---|
| 3 | 1.00000 | −6.31596E−03 | −2.32955E−01 | 1.17308E−01 | −7.34522E−01 |
| | A₇ | A₈ | A₉ | A₁₀ | A₁₁ |
| | −1.75874E−01 | 7.66993E−01 | 6.69724E−01 | −1.07413E+00 | −3.99807E+00 |
| | A₁₂ | A₁₃ | HD 14 | A₁₅ | A₁₆ |
| | −5.06639E+00 | 4.24323E−01 | 1.52242E+01 | 2.52247E+01 | −5.44675E+01 |

*Aspheric surface

In addition, Table 16 shows numerical values corresponding to the conditional expressions according to Example 6.

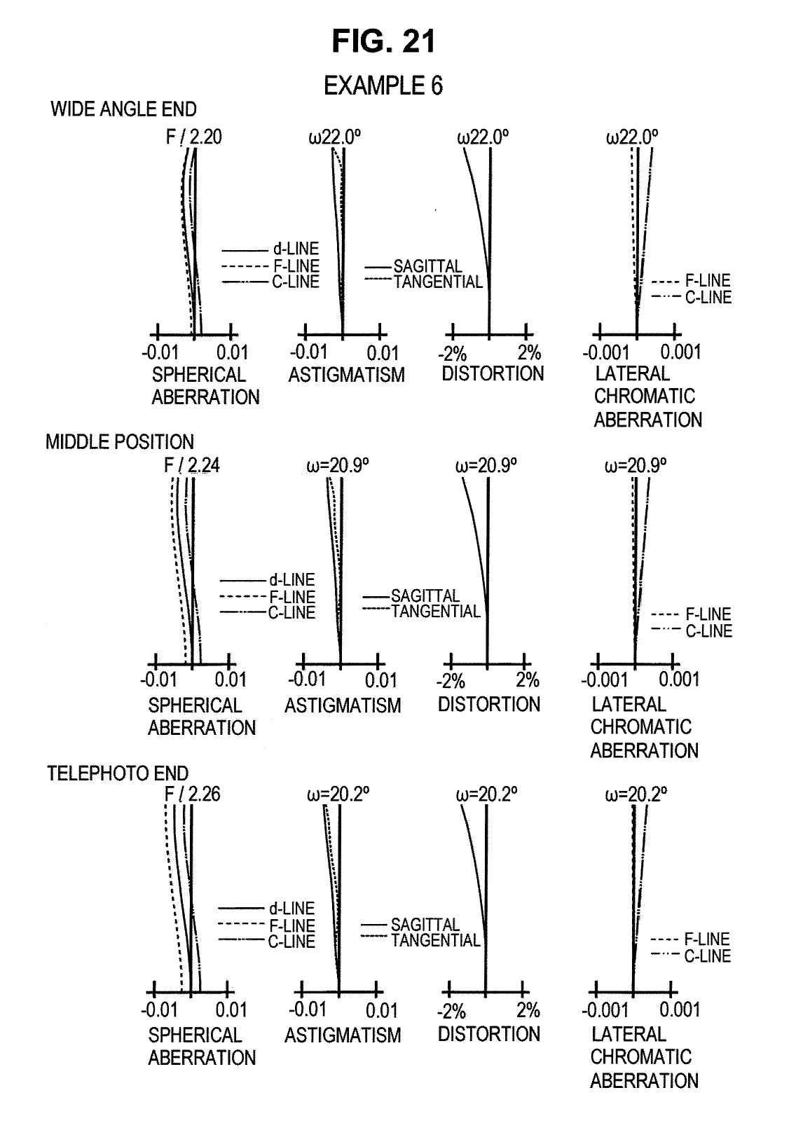

FIG. 21 is an aberration diagram illustrating all aberrations (spherical aberration, astigmatism, distortion, and lateral chromatic aberration) of the projection variable focus lens according to Example 6 at the wide angle end (wide), the middle position (middle), and the telephoto end (tele).

As can be seen from FIG. 21, the projection variable focus lens according to Example 6 has an angle of view 2ω of 44.0 degrees, which is a wide angle, and an F number of 2.20, which is a large value, at the wide angle end. Therefore, all aberrations are effectively corrected.

In addition, as shown in Table 16, the projection variable focus lens according to Example 6 satisfies all of Conditional expressions 1 and 2 and Conditional expressions 1′ and 2′.

### Second Example Group

A second example group includes projection variable focus lenses according to Examples 7 and 8. Each of the projection variable focus lenses includes a first lens group G₁ including a first lens L₁, a second lens group G₂ including a second lens L₂ and a third lens L₃, and a third lens group G₃ including fourth to sixth lenses L₄ to L₆. When power varies, the second lens group G₂ and the third lens group G₃ are independently moved.

### Example 7

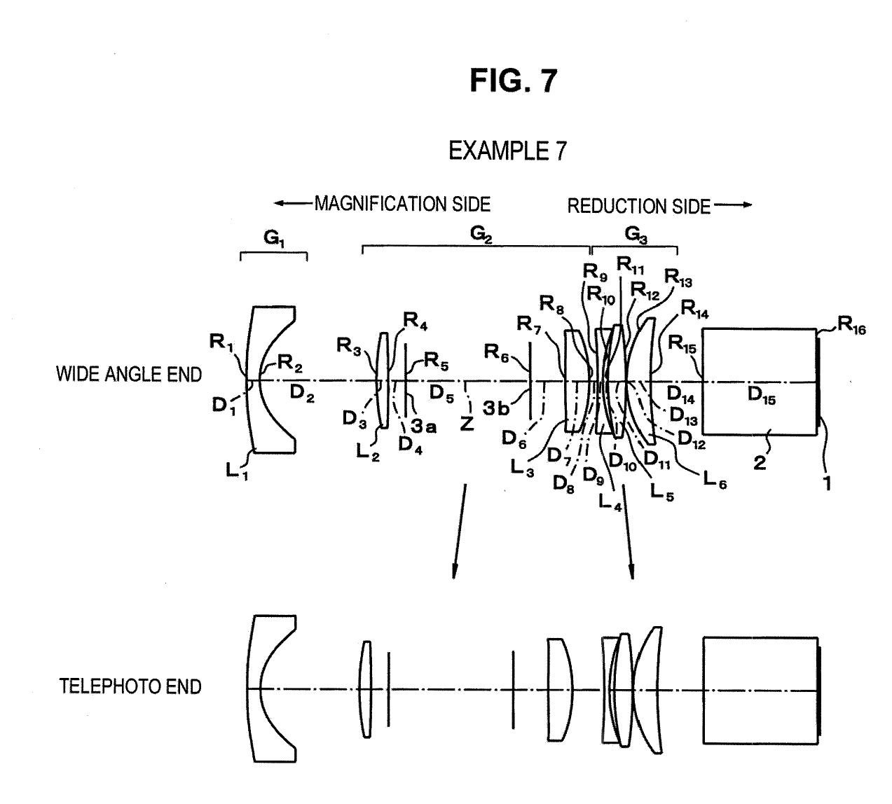

The projection variable focus lens according to Example 7 has the structure shown in FIG. 7.

That is, the projection variable focus lens includes the first to sixth lenses L₁ to L₆ of the first to third lens groups G₁ to G₃ arranged in this order from the magnification side. The first lens group G₁ includes the first lens L₁, which is a negative meniscus lens (on the axis) having aspheric surfaces at both sides, one of which is a concave surface facing the reduction side. The second lens group G₂ includes the second lens L₂, which is a biconvex lens, the masks 3a and 3b, and the third lens L₃ which is an aspheric biconvex lens (on the axis). The third lens group G₃ includes the fourth lens L₄, which is a biconcave lens, the fifth lens L₅, which is a biconvex lens, and the sixth lens L₆, which is a positive meniscus lens having a concave surface facing the reduction side.

When power varies from the wide angle end to the telephoto end, the second lens group G₂ is moved to the magnification side along the optical axis Z, and the third lens group G₃ is moved to the reduction side along the optical axis Z.

Focusing is performed by moving the third lens group G₃ in the direction of the optical axis Z (varifocal lens type).

In Table 7, an upper part shows the curvature radius R of each lens surface according to Example 7, the thickness of the center of each lens and the air space D between the lenses, and the refractive index Nd and the Abbe number νd of each lens with respect to the d-line.

In Table 7, a middle part shows the variable spacing 1, the variable spacing 2, and a variable spacing 3 (the gap between the third lens group G₃ and the glass block 2: movement 3 (which is the same as that in the following Tables 8 to 10)) at the wide angle end (wide), the middle position (middle), and the telephoto end (tele). In Table 7, a lower part shows the values of the constants K and A₃ to A₁₆ corresponding to the aspheric surfaces.

TABLE 7
Focal length F = 1.00~1.06~1.10

| Surface | R | D | Nd | νd |
|---|---|---|---|---|
| 1* | 7.310 | 0.157 | 1.4910 | 57.6 |
| 2* | 0.700 | (Movement 1) | | |
| 3 | 2.789 | 0.141 | 1.8040 | 46.6 |
| 4 | −14.023 | 0.210 | | |
| 5 (Mask) | ∞ | 1.493 | | |
| 6 (Mask) | ∞ | 0.420 | | |
| 7* | 9.806 | 0.289 | 1.5686 | 58.6 |
| 8* | −1.646 | (Movement 2) | | |
| 9 | −8.452 | 0.060 | 1.8052 | 25.4 |
| 10 | 1.628 | 0.060 | | |
| 11 | 2.819 | 0.220 | 1.6204 | 60.3 |
| 12 | −4.756 | 0.005 | | |
| 13 | 1.248 | 0.279 | 1.6031 | 60.6 |
| 14 | 5.278 | (Movement 3) | | |
| 15 | ∞ | 1.364 | 1.5163 | 64.1 |
| 16 | ∞ | | | |

| | Wide | Middle | Telephoto |
|---|---|---|---|
| Movement spacing | angle end | position | end |
| Movement 1 | 1.395 | 1.265 | 1.182 |
| Movement 2 | 0.101 | 0.277 | 0.384 |
| Movement 3 | 0.624 | 0.579 | 0.5556 |

Aspheric coefficient

| Surface number | K | A₃ | A₄ | A₅ | A₆ |
|---|---|---|---|---|---|
| 1 | 67.48964 | −1.83430E−01 | 1.62708E+00 | −3.26243E+00 | 1.81934E+00 |
| | A₇ | A₈ | A₉ | A₁₀ | A₁₁ |
| | 1.10830E+00 | 3.18019E−01 | −2.66515E+00 | 2.51994E−01 | −3.21829E+00 |
| | A₁₂ | A₁₃ | HD 14 | A₁₅ | A₁₆ |
| | 6.06503E+00 | 1.50501E+01 | −4.12977E+01 | 3.54122E+01 | −1.12108E+01 |
| | K | A₃ | A₄ | A₅ | A₆ |
| 2 | 0.44634 | −1.67932E−01 | 1.50166E+00 | −1.71285E+00 | −3.59094E+00 |
| | A₇ | A₈ | A₉ | A₁₀ | A₁₁ |
| | 7.37357E+00 | 2.43823E+00 | −6.49263E+00 | −9.96624E+00 | 9.06881E+00 |
| | A₁₂ | A₁₃ | HD 14 | A₁₅ | A₁₆ |
| | −1.74065E+01 | 4.46604E+01 | −3.76068E+01 | 7.18290E+01 | −7.39605E+01 |
| | K | A₄ | A₆ | A₈ | A₁₀ |
| 7 | 1.00000 | −5.75174E−02 | −2.27995E−01 | 1.72895E−01 | −1.15846E+00 |
| | K | A₄ | A₆ | A₈ | A₁₀ |
| 8 | 1.00000 | 0.00000E+00 | −1.79412E−02 | −4.47250E−02 | −3.46915E−01 |

*Aspheric surface

In addition, Table 16 shows numerical values corresponding to the conditional expressions according to Example 7.

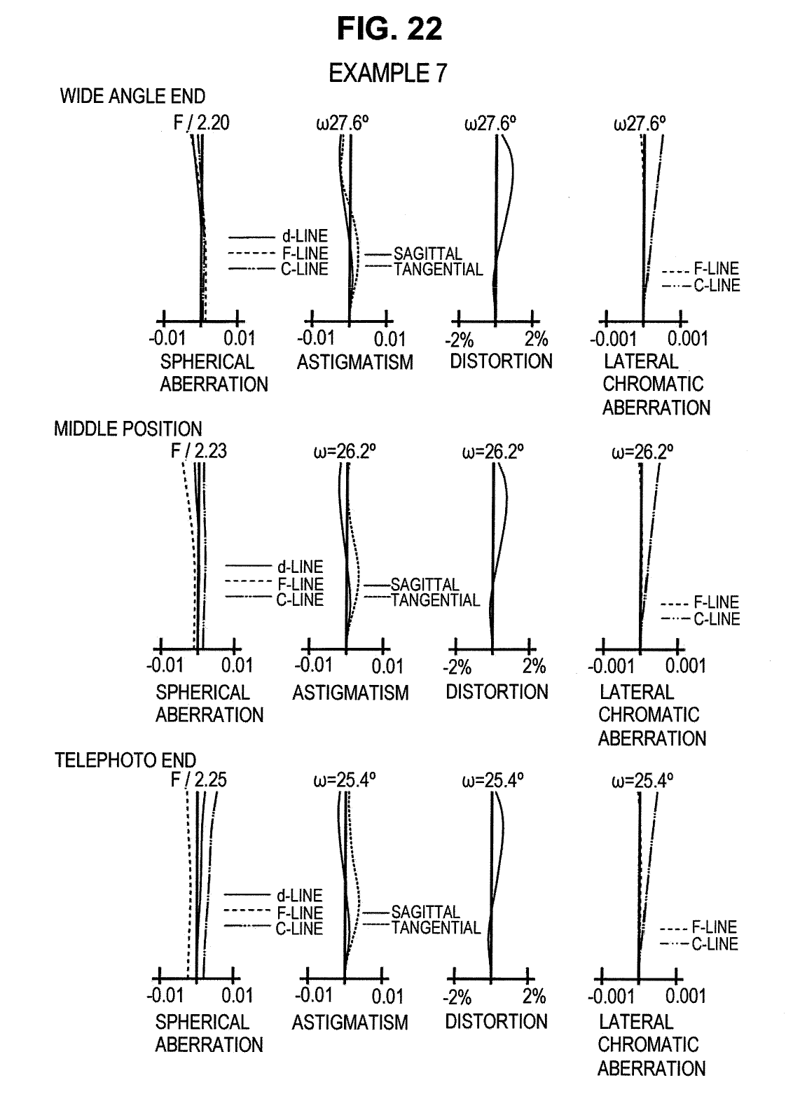

FIG. 22 is an aberration diagram illustrating all aberrations (spherical aberration, astigmatism, distortion, and lateral chromatic aberration) of the projection variable focus lens according to Example 7 at the wide angle end (wide), the middle position (middle), and the telephoto end (tele).

As can be seen from FIG. 22, the projection variable focus lens according to Example 7 has an angle of view 2ω of 55.2 degrees, which is a wide angle, and an F number of 2.20, which is a large value, at the wide angle end. Therefore, all aberrations are effectively corrected.

In addition, as shown in Table 16, the projection variable focus lens according to Example 7 satisfies all of Conditional expressions 1 and 2 and Conditional expressions 1′ and 2′.

### Example 8

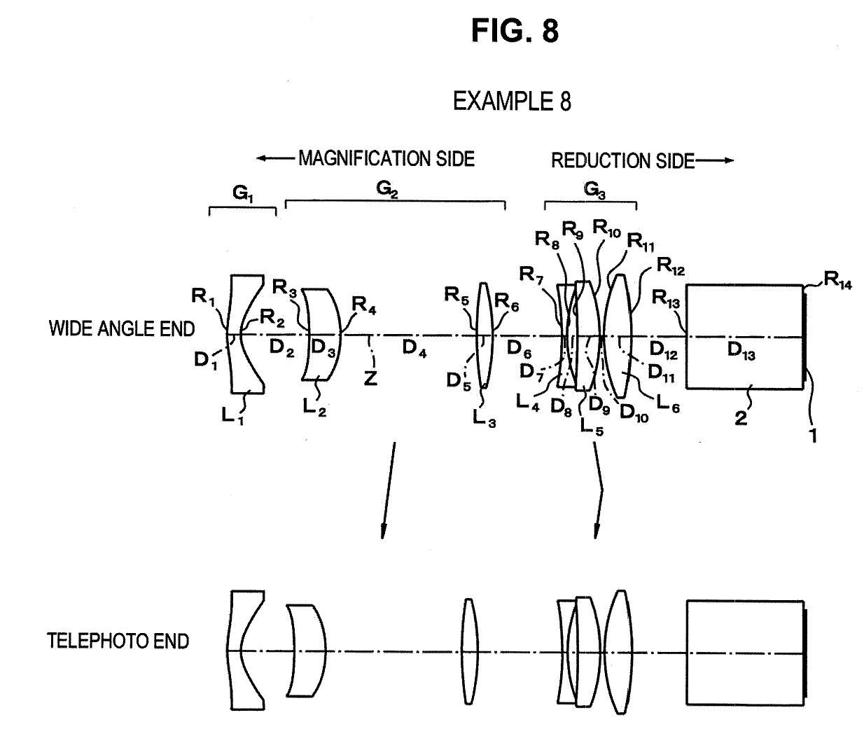

The projection variable focus lens according to Example 8 has the structure shown in FIG. 8.

That is, the projection variable focus lens has substantially the same structure as that according to Example 7 except that the second lens L₂ is a positive meniscus lens (on the axis) having aspheric surfaces at both sides, one of which is a convex surface facing the reduction side, the third lens L₃ is a spherical biconvex lens, and the sixth lens L₆ is a biconvex lens. In addition, no mask is provided on the optical path.

When power varies from the wide angle end to the telephoto end, the second lens group G₂ is moved to the magnification side along the optical axis Z, and the third lens group G₃ is moved to the reduction side along the optical axis Z and is the moved to the magnification side.

Focusing is performed by moving the third lens group G₃ in the direction of the optical axis Z (varifocal lens type).

In Table 8, an upper part shows the curvature radius R of each lens surface according to Example 8, the thickness of the center of each lens and the air space D between the lenses, and the refractive index Nd and the Abbe number νd of each lens with respect to the d-line.

In Table 8, a middle part shows the variable spacing 1, the variable spacing 2, and the variable spacing 3 at the wide angle end (wide), the middle position (middle), and the telephoto end (tele). In Table 8, a lower part shows the values of the constants K and A₃ to A₁₆ corresponding to the aspheric surfaces.

TABLE 8
Focal length F = 1.00~1.06~1.10

| Surface | R | D | Nd | νd |
|---|---|---|---|---|
| 1* | 0.777 | 0.124 | 1.4910 | 57.6 |
| 2* | 0.323 | (Movement 1) | | |
| 3* | −2.747 | 0.290 | 1.4910 | 57.6 |
| 4* | −0.862 | 1.260 | | |
| 5 | 2.920 | 0.149 | 1.6204 | 60.3 |
| 6 | −1.897 | (Movement 2) | | |
| 7 | −2.568 | 0.048 | 1.8052 | 25.4 |
| 8 | 1.206 | 0.095 | | |
| 9 | −5.984 | 0207 | 1.6204 | 60.3 |
| 10 | −1.385 | 0.039 | | |
| 11 | 1.353 | 0.250 | 1.6204 | 60.3 |
| 12 | −2.606 | (Movement 3) | | |
| 13 | ∞ | 1.079 | 1.5163 | 64.1 |
| 14 | ∞ | | | |

| | Wide | Middle | Telephoto |
|---|---|---|---|
| Movement spacing | angle end | position | end |
| Movement 1 | 0.632 | 0.549 | 0.491 |
| Movement 2 | 0.643 | 0.735 | 0.785 |
| Movement 3 | 0.510 | 0.501 | 0.509 |

Aspheric coefficient

| Surface number | K | A₃ | A₄ | A₅ | A₆ |
|---|---|---|---|---|---|
| 1 | −9.93185 | −1.12303E−01 | −1.31375E+00 | −3.46099E+00 | 1.28710E+01 |
| | A₇ | A₈ | A₉ | A₁₀ | A₁₁ |
| | 4.00064E+00 | −9.39662E+00 | −3.44515E+01 | −1.17116E+01 | −3.20069E+01 |
| | A₁₂ | A₁₃ | HD 14 | A₁₅ | A₁₆ |
| | 1.17760E+02 | 3.69728E+02 | −6.09831E+02 | 1.18202E+03 | −1.75085E+03 |
| | K | A₃ | A₄ | A₅ | A₆ |
| 2 | −0.42001 | −5.89650E−02 | −4.89547E+00 | 8.04173E+00 | −3.66448E+00 |
| | A₇ | A₈ | A₉ | A₁₀ | A₁₁ |
| | 2.55864E+01 | 3.57186E+00 | −6.73390E+01 | −1.76565E+02 | −9.33973E+01 |
| | A₁₂ | A₁₃ | HD 14 | A₁₅ | A₁₆ |
| | −2.48233E+02 | 1.82882E+03 | 2.82145E+03 | 6.72980E+03 | −2.49383E+04 |
| | K | A₃ | A₄ | A₅ | A₆ |
| 3 | 1.00000 | 0.00000E+00 | −4.48970E−01 | −3.82727E+00 | 1.52517E+01 |
| | A₇ | A₈ | A₉ | A₁₀ | |
| | −3.17255E+01 | −3.84669E+01 | 2.67581E+02 | −3.48409E+02 | |
| | K | A₃ | A₄ | A₅ | A₆ |
| 4 | 1.00000 | 0.00000E+00 | −2.93940E−01 | 1.63067E−01 | −5.66100E+00 |
| | A₇ | A₈ | A₉ | A₁₀ | |
| | 1.28808E+01 | 1.13938E+01 | −7.52084E+01 | 5.74560E+01 | |

*Aspheric surface

In addition, Table 16 shows numerical values corresponding to the conditional expressions according to Example 8.

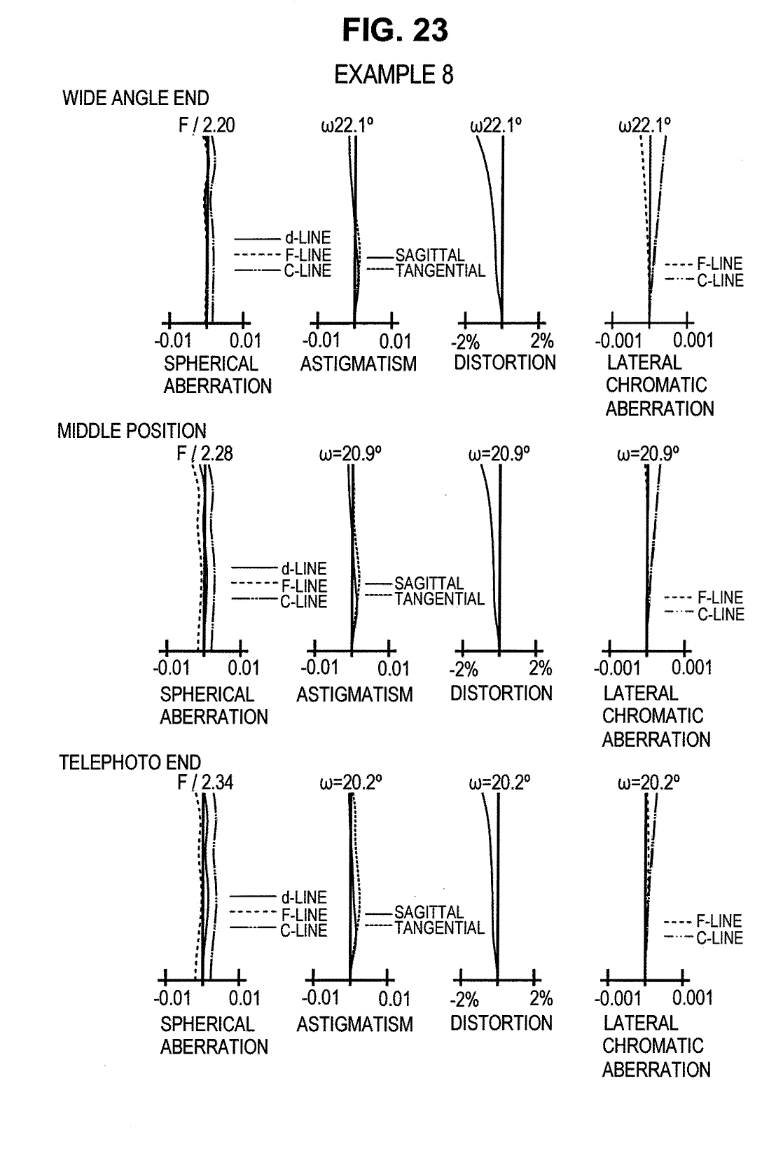

FIG. 23 is an aberration diagram illustrating all aberrations (spherical aberration, astigmatism, distortion, and lateral chromatic aberration) of the projection variable focus lens according to Example 8 at the wide angle end (wide), the middle position (middle), and the telephoto end (tele).

As can be seen from FIG. 23, the projection variable focus lens according to Example 8 has an angle of view 2ω of 44.2 degrees, which is a wide angle, and an F number of 2.20, which is a large value, at the wide angle end. Therefore, all aberrations are effectively corrected.

In addition, as shown in Table 16, the projection variable focus lens according to Example 8 satisfies all of Conditional expressions 1 and 2 and Conditional expressions 1′ and 2′.

### Third Example Group

A third example group includes projection variable focus lenses according to Examples 9 and 10. Each of the projection variable focus lenses includes a first lens group G₁ including a first lens L₁, a second lens group G₂ including a second lens L₂ and a third lens L₃, and a third lens group G₃ including fourth to sixth lenses L₄ to L₆. When power varies, the first lens group G₁, the second lens group G₂, and the third lens group G₃ are independently moved.

### Example 9

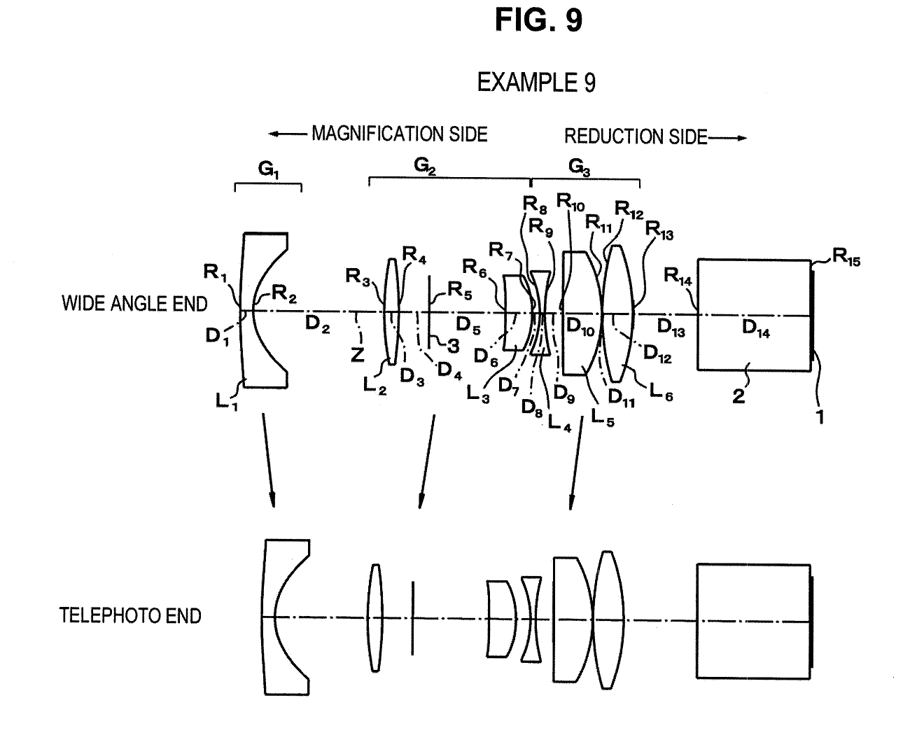

The projection variable focus lens according to Example 9 has the structure shown in FIG. 9.

That is, the projection variable focus lens includes the first to sixth lenses L₁ to L₆ of the first to third groups G₁ to G₃ arranged in this order from the magnification side. The first lens group G₁ includes the first lens L₁ which is a negative meniscus lens (on the axis) having aspheric surfaces at both sides, one of which is a concave surface facing the reduction side. The second lens group G₂ includes the second lens L₂, which is a biconvex lens, the mask 3, and the third lens L₃, which is a positive meniscus lens (on the axis) having aspheric surfaces at both sides, one of which is a convex surface facing the reduction side. The third lens group G₃ includes the fourth lens L₄, which is a biconcave lens, the fifth lens L₅, which is a biconvex lens, and the sixth lens L₆, which is a biconvex lens.

When power varies from the wide angle end to the telephoto end, the first lens group G₁ is moved to the reduction side along the optical axis Z, the second lens group G₂ is moved to the magnification side along the optical axis Z, and the third lens group G₃ is moved to the magnification side along the optical axis Z.

Focusing is performed by moving the first lens group G₁ in the direction of the optical axis Z (varifocal lens type).

In Table 9, an upper part shows the curvature radius R of each lens surface according to Example 9, the thickness of the center of each lens and the air space D between the lenses, and the refractive index Nd and the Abbe number νd of each lens with respect to the d-line.

In Table 9, a middle part shows the variable spacing 1, the variable spacing 2, and the variable spacing 3 at the wide angle end (wide), the middle position (middle), and the telephoto end (tele). In Table 9, a lower part shows the values of the constants K and A₃ to A₁₆ corresponding to the aspheric surfaces.

TABLE 9
Focal length F = 1.00~1.08~1.15

| Surface | R | D | Nd | νd |
|---|---|---|---|---|
| 1* | 4.227 | 0.157 | 1.4910 | 57.6 |
| 2* | 0.664 | (Movement 1) | | |
| 3 | 3.220 | 0.176 | 1.8340 | 37.2 |
| 4 | −4.479 | 0.367 | | |
| 5 (Mask) | ∞ | 0.926 | | |
| 6* | −13.879 | 0.325 | 1.5686 | 58.6 |
| 7* | −1.006 | (Movement 2) | | |
| 8 | −1.085 | 0.060 | 1.7847 | 26.3 |
| 9 | 1.910 | 0.218 | | |
| 10 | 57.973 | 0.472 | 1.6204 | 60.3 |
| 11 | −1.472 | 0.005 | | |
| 12 | 2.847 | 0.370 | 1.6031 | 60.6 |
| 13 | −2.247 | (Movement 3) | | |
| 14 | ∞ | 1.363 | 1.5163 | 64.1 |
| 15 | ∞ | | | |

| | Wide | Middle | Telephoto |
|---|---|---|---|
| Movement spacing | angle end | position | end |
| Movement 1 | 1.581 | 1.318 | 1.121 |
| Movement 2 | 0.091 | 0.135 | 0.177 |
| Movement 3 | 0.776 | 0.832 | 0.878 |

Aspheric coefficient

| Surface number | K | A₃ | A₄ | A₅ | A₆ |
|---|---|---|---|---|---|
| 1 | 19.73745 | −3.82093E−01 | 1.59402E+00 | −3.14213E+00 | 1.87358E+00 |
| | A₇ | A₈ | A₉ | A₁₀ | A₁₁ |
| | 1.05396E+00 | 2.65857E−01 | −2.65380E+00 | 3.39857E−01 | −3.16601E+00 |
| | A₁₂ | A₁₃ | HD 14 | A₁₅ | A₁₆ |
| | 6.08993E+00 | 1.50161E+01 | −4.19189E+01 | 3.56454E+01 | −1.08371E+01 |
| | K | A₃ | A₄ | A₅ | A₆ |
| 2 | 0.67621 | −3.84404E−01 | 1.31989E+00 | −1.50390E+00 | −3.92755E+00 |
| | A₇ | A₈ | A₉ | A₁₀ | A₁₁ |
| | 7.00458E+00 | 2.59073E+00 | −5.71807E+00 | −8.92179E+00 | 9.74289E+00 |
| | A₁₂ | A₁₃ | HD 14 | A₁₅ | A₁₆ |
| | −1.86974E+01 | 4.07523E+01 | −4.52313E+01 | 6.80545E+01 | −5.46451E+01 |
| | K | A₃ | A₄ | A₅ | A₆ |
| 6 | 1.00000 | 0.00000E+00 | −2.62761E−01 | −1.30655E−01 | 2.22763E+00 |
| | A₇ | A₈ | A₉ | A₁₀ | |
| | −1.06829E+01 | −2.92129E+00 | 7.15935E+01 | −1.01720E+02 | |
| | K | A₃ | A₄ | A₅ | A₆ |
| 7 | 1.00000 | 0.00000E+00 | −8.10087E−02 | −2.20841E−01 | 2.66994E−01 |
| | A₇ | A₈ | A₉ | A₁₀ | |
| | −8.09949E−01 | −5.93549E−01 | −4.28461E−01 | −2.78301E+00 | |

*Aspheric surface

In addition, Table 16 shows numerical values corresponding to the conditional expressions according to

### Example 9

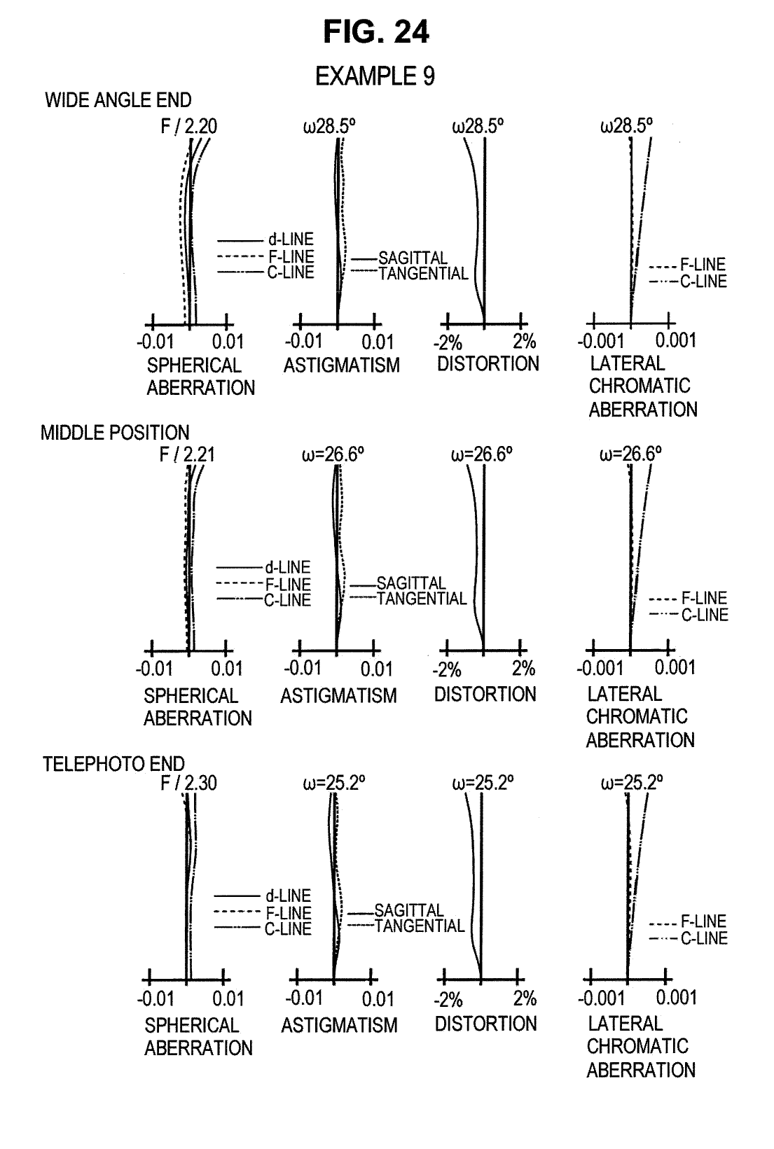

FIG. 24 is an aberration diagram illustrating all aberrations (spherical aberration, astigmatism, distortion, and lateral chromatic aberration) of the projection variable focus lens according to Example 9 at the wide angle end (wide), the middle position (middle), and the telephoto end (tele).

As can be seen from FIG. 24, the projection variable focus lens according to Example 9 has an angle of view 2ω of 57.0 degrees, which is a wide angle, and an F number of 2.20, which is a large value, at the wide angle end. Therefore, all aberrations are effectively corrected.

In addition, as shown in Table 16, the projection variable focus lens according to Example 9 satisfies all of Conditional expressions 1 and 2 and Conditional expressions 1′ and 2′.

### Example 10

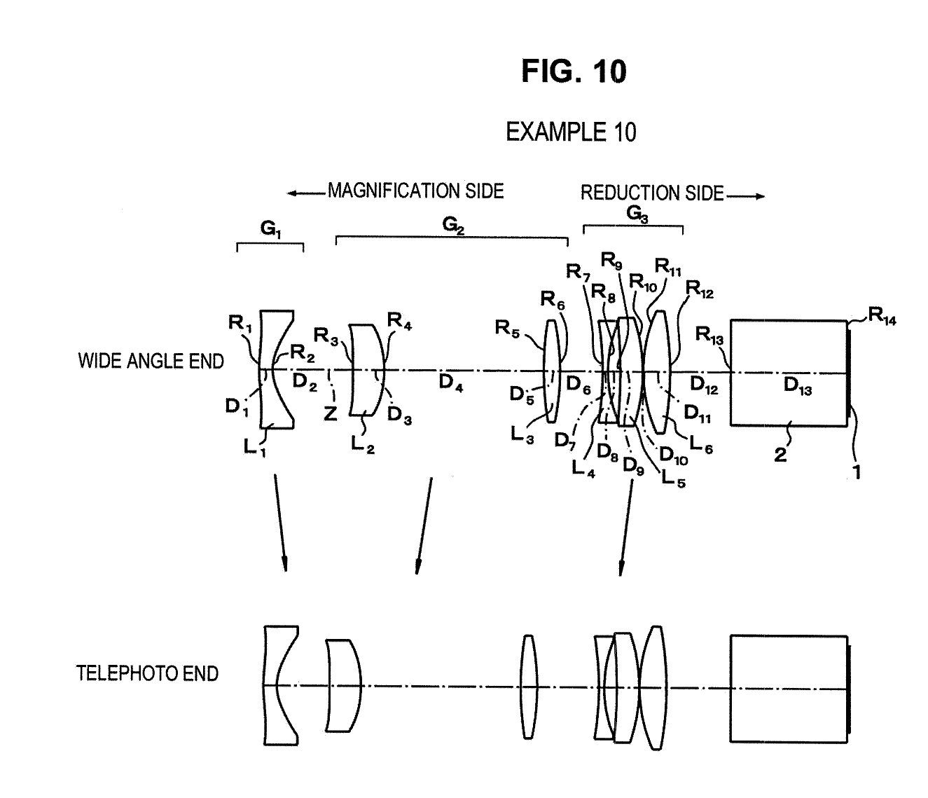

The projection variable focus lens according to Example 10 has the structure shown in FIG. 10.

That is, the projection variable focus lens has substantially the same structure as that according to Example 9 except that the second lens L₂ is a positive meniscus lens (on the axis) having aspheric surfaces at both sides, one of which is a convex surface facing the reduction side, the third lens L₃ is a spherical biconvex lens, and the fifth lens L₅ is a positive meniscus lens having a convex surface facing the reduction side. In addition, no mask is provided on the optical path.

Similar to Example 9, when power varies from the wide angle end to the telephoto end, the first lens group G₁ is moved to the reduction side along the optical axis Z, the second lens group G₂ is moved to the magnification side along the optical axis Z, and the third lens group G₃ is moved to the magnification side along the optical axis Z.

Focusing is performed by moving the first lens group G₁ in the direction of the optical axis Z (varifocal lens type).

In Table 10, an upper part shows the curvature radius R of each lens surface according to Example 10, the thickness of the center of each lens and the air space D between the lenses, and the refractive index Nd and the Abbe number νd of each lens with respect to the d-line.

In Table 10, a middle part shows the variable spacing 1, the variable spacing 2, and the variable spacing 3 at the wide angle end (wide), the middle position (middle), and the telephoto end (tele). In Table 10, a lower part shows the values of the constants K and A₃ to A₁₆ corresponding to the aspheric surfaces.

TABLE 10
Focal length F = 1.00~1.08~1.15

| Surface | R | D | Nd | νd |
|---|---|---|---|---|
| 1* | 1.119 | 0.124 | 1.4910 | 57.6 |
| 2* | 0.371 | (Movement 1) | | |
| 3* | −27.505 | 0.291 | 1.4910 | 57.6 |
| 4* | −0.976 | 1.485 | | |
| 5 | 2.861 | 0.153 | 1.7130 | 53.9 |
| 6 | −2.242 | (Movement 2) | | |
| 7 | −2.870 | 0.048 | 1.8052 | 25.4 |
| 8 | 1.135 | 0.116 | | |
| 9 | −4.545 | 0.208 | 1.6204 | 60.3 |
| 10 | −1.533 | 0.004 | | |
| 11 | 1.332 | 0.251 | 1.6204 | 60.3 |
| 12 | −2.883 | (Movement 3) | | |
| 13 | ∞ | 1.079 | 1.5163 | 64.1 |
| 14 | ∞ | | | |

| | Wide | Middle | Telephoto |
|---|---|---|---|
| Movement spacing | angle end | position | end |
| Movement 1 | 0.745 | 0.599 | 0.489 |
| Movement 2 | 0.393 | 0.488 | 0.573 |
| Movement 3 | 0.557 | 0.576 | 0.591 |

Aspheric coefficient

| Surface number | K | A₃ | A₄ | A₅ | A₆ |
|---|---|---|---|---|---|
| 1 | −27.60823 | −1.07908E−01 | −8.84656E−01 | −3.52837E+00 | 1.18953E+01 |
| | A₇ | A₈ | A₉ | A₁₀ | A₁₁ |
| | 2.94693E+00 | −9.14478E+00 | −3.18698E+01 | −7.25051E+00 | −2.84450E+01 |
| | A₁₂ | A₁₃ | HD 14 | A₁₅ | A₁₆ |
| | 1.15393E+02 | 3.57299E+02 | −6.31068E+02 | 1.16711E+03 | −1.71843E+03 |
| | K | A₃ | A₄ | A₅ | A₆ |
| 2 | −0.26277 | −5.83701E−02 | −4.77926E+00 | 8.47067E+00 | −4.76721E+00 |
| | A₇ | A₈ | A₉ | A₁₀ | A₁₁ |
| | 2.17842E+01 | 1.41089E−01 | −6.02598E+01 | −1.44182E+02 | −3.56115E+01 |
| | A₁₂ | A₁₃ | HD 14 | A₁₅ | A₁₆ |
| | −2.27573E+02 | 1.61661E+03 | 2.11181E+03 | 5.97718E+03 | −2.16064E+04 |
| | K | A₃ | A₄ | A₅ | A₆ |
| 3 | 1.00000 | 0.00000E+00 | −3.18867E−01 | −3.44096E+00 | 1.49483E+01 |
| | A₇ | A₈ | A₉ | A₁₀ | |
| | −3.13696E+01 | −3.97004E+01 | 2.61670E+02 | −3.25757E+02 | |
| | K | A₃ | A₄ | A₅ | A₆ |
| 4 | 1.00000 | 0.00000E+00 | −2.74415E−01 | 2.60149E−01 | −5.62992E+00 |
| | A₇ | A₈ | A₉ | A₁₀ | |
| | 1.17277E+01 | 1.07634E+01 | −6.59953E+01 | 4.51268E+01 | |

*Aspheric surface

In addition, Table 16 shows numerical values corresponding to the conditional expressions according to Example 10.

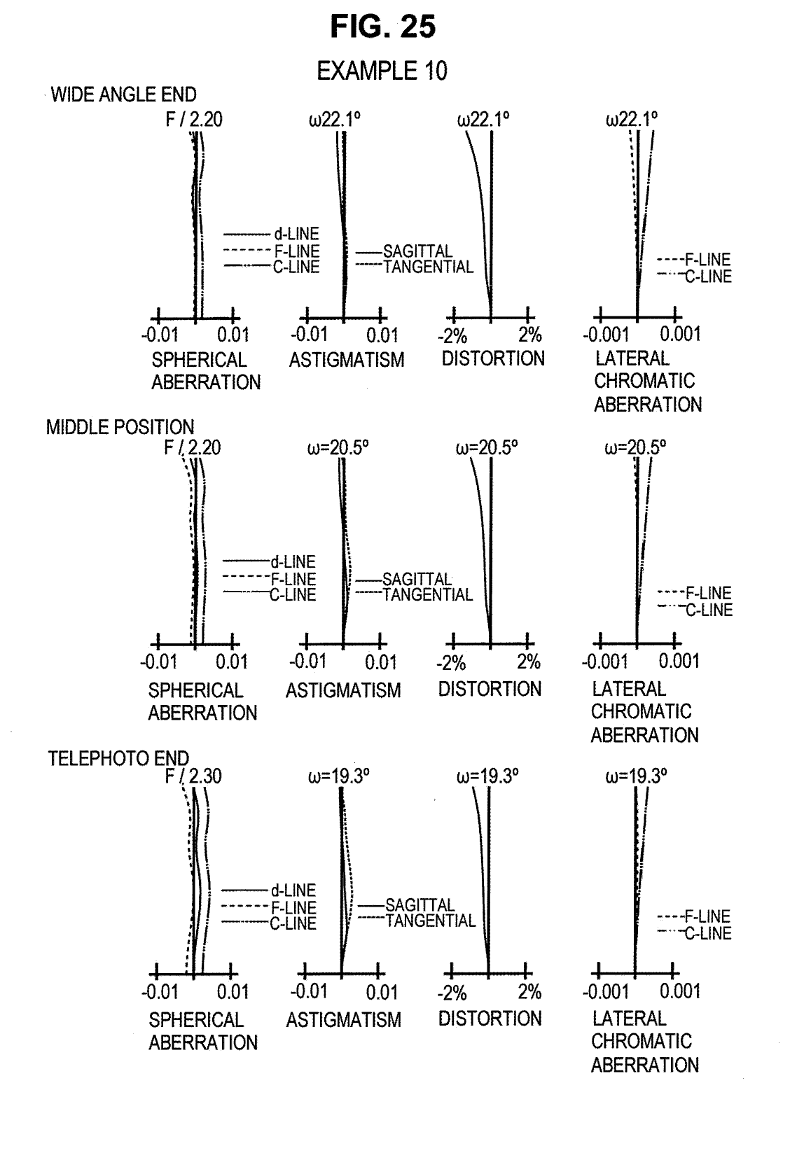

FIG. 25 is an aberration diagram illustrating all aberrations (spherical aberration, astigmatism, distortion, and lateral chromatic aberration) of the projection variable focus lens according to Example 10 at the wide angle end (wide), the middle position (middle), and the telephoto end (tele).

As can be seen from FIG. 25, the projection variable focus lens according to Example 10 has an angle of view 2ω of 44.2 degrees, which is a wide angle, and an F number of 2.20, which is a large value, at the wide angle end. Therefore, all aberrations are effectively corrected.

In addition, as shown in Table 16, the projection variable focus lens according to Example 10 satisfies all of Conditional expressions 1 and 2 and Conditional expressions 1′ and 2′.

### Fourth Example Group

A fourth example group includes projection variable focus lenses according to Examples 11 to 13. Each of the projection variable focus lenses includes a first lens group G₁ including a first lens L₁, a second lens group G₂ including a second lens L₂, a third lens group G₃ including a third lens L₃, and a fourth lens group G₄ including fourth to sixth lenses L₄ to L₆. When power varies, the second lens group G₂ and the third lens group G₃ are independently moved.

### Example 11

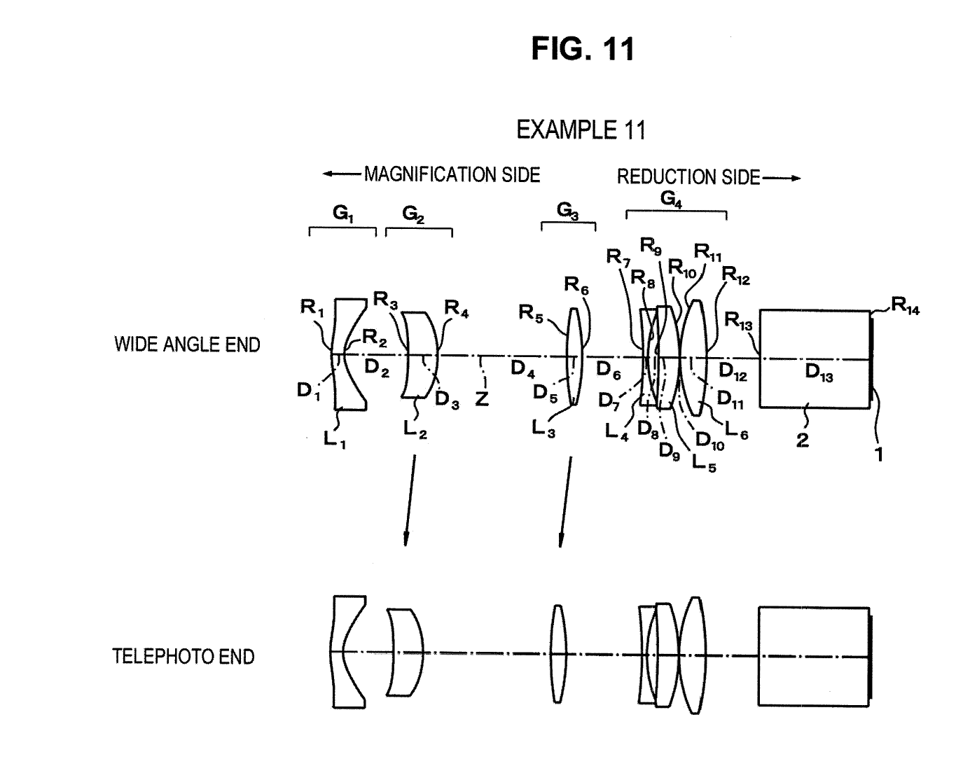

The projection variable focus lens according to Example 11 has the structure shown in FIG. 11.

That is, the projection variable focus lens includes the first to sixth lenses L₁ to L₆ of the first to fourth lens groups G₁ to G₄ arranged in this order from the magnification side. The first lens group G₁ includes the first lens L₁ which is a negative meniscus lens (on the axis) having aspheric surfaces at both sides, one of which is a concave surface facing the reduction side. The second lens group G₂ includes the second lens L₂ which is a negative meniscus lens (on the axis) having aspheric surfaces at both sides, one of which is a convex surface facing the reduction side. The third lens group G₃ includes the fourth lens L₄ which is a biconvex lens. The fourth lens group G₄ includes the fourth lens L₄, which is a biconcave lens, the fifth lens L₅, which is a positive meniscus lens having a convex surface facing the reduction side, and the sixth lens L₆, which is a biconvex lens.

When power varies from the wide angle end to the telephoto end, the second lens group G₂ and the third lens group G₃ are moved to the magnification side along the optical axis Z.

Focusing is performed by moving the third lens group G₃ in the direction of the optical axis Z (varifocal lens type).

In Table 11, an upper part shows the curvature radius R of each lens surface according to Example 11, the thickness of the center of each lens and the air space D between the lenses, and the refractive index Nd and the Abbe number νd of each lens with respect to the d-line.

In Table 11, a middle part shows the variable spacing 1, the variable spacing 2, and the variable spacing 3 (the gap between the third lens group G₃ and the fourth lens group G₄: movement 3 (which is the same as that in the following Tables 12 to 16)) at the wide angle end (wide), the middle position (middle), and the telephoto end (tele). In Table 11, a lower part shows the values of the constants K and A₃ to A₁₆ corresponding to the aspheric surfaces.

TABLE 11
Focal length F = 1.00~1.06~1.10

| Surface | R | D | Nd | νd |
|---|---|---|---|---|
| 1* | 0.724 | 0.125 | 1.4910 | 57.6 |
| 2* | 0.303 | (Movement 1) | | |
| 3* | −3.457 | 0.291 | 1.4910 | 57.6 |
| 4* | −0.860 | (Movement 2) | | |
| 5 | 2.595 | 0.153 | 1.5891 | 61.1 |
| 6 | −1.938 | (Movement 3) | | |
| 7 | −3.781 | 0.048 | 1.8052 | 25.4 |
| 8 | 1.118 | 0.106 | | |
| 9 | −6.089 | 0.207 | 1.5891 | 61.1 |
| 10 | −1.439 | 0.004 | | |
| 11 | 1.282 | 0.255 | 1.5891 | 61.1 |
| 12 | −2.613 | 0.515 | | |
| 13 | ∞ | 1.079 | 1.5163 | 64.1 |
| 14 | ∞ | | | |

| | Wide | Middle | Telephoto |
|---|---|---|---|
| Movement spacing | angle end | position | end |
| Movement 1 | 0.627 | 0.544 | 0.494 |
| Movement 2 | 1.271 | 1.266 | 1.257 |
| Movement 3 | 0.598 | 0.687 | 0.745 |

Aspheric coefficient

| Surface number | K | A₃ | A₄ | A₅ | A₆ |
|---|---|---|---|---|---|
| 1 | −9.13657 | −1.70179E−01 | −1.60630E+00 | −3.33400E+00 | 1.31033E+01 |
| | A₇ | A₈ | A₉ | A₁₀ | A₁₁ |
| | 5.41257E+00 | −7.06642E+00 | −3.46100E+01 | −2.15579E+01 | −5.73348E+01 |
| | A₁₂ | A₁₃ | HD 14 | A₁₅ | A₁₆ |
| | 8.85697E+01 | 3.97474E+02 | −4.03996E+02 | 1.53106E+03 | −2.46248E+03 |
| | K | A₃ | A₄ | A₅ | A₆ |
| 2 | −0.54299 | −1.60587E−01 | −4.84044E+00 | 8.47179E+00 | −3.58447E+00 |
| | A₇ | A₈ | A₉ | A₁₀ | A₁₁ |
| | 2.45903E+01 | 4.20427E+00 | −6.14806E+01 | −1.67116E+02 | −1.00403E+02 |
| | A₁₂ | A₁₃ | HD 14 | A₁₅ | A₁₆ |
| | −3.25261E+02 | 1.58079E+03 | 2.41145E+03 | 6.94045E+03 | −2.03651E+04 |
| | K | A₃ | A₄ | A₅ | A₆ |
| 3 | 1.00000 | 0.00000E+00 | −4.67531E−01 | −3.31198E+00 | 1.27181E+01 |
| | A₇ | A₈ | A₉ | A₁₀ | |
| | −3.07916E+01 | −2.87616E+01 | 2.62454E+02 | −3.71959E+02 | |
| | K | A₃ | A₄ | A₅ | A₆ |
| 4 | 1.00000 | 0.00000E+00 | −2.22993E−01 | −3.35778E−01 | −4.70175E+00 |
| | A₇ | A₈ | A₉ | A₁₀ | |
| | 1.28298E+01 | 8.23784E+00 | −7.11604E+01 | 5.34320E+01 | |

*Aspheric surface

In addition, Table 16 shows numerical values corresponding to the conditional expressions according to Example 11.

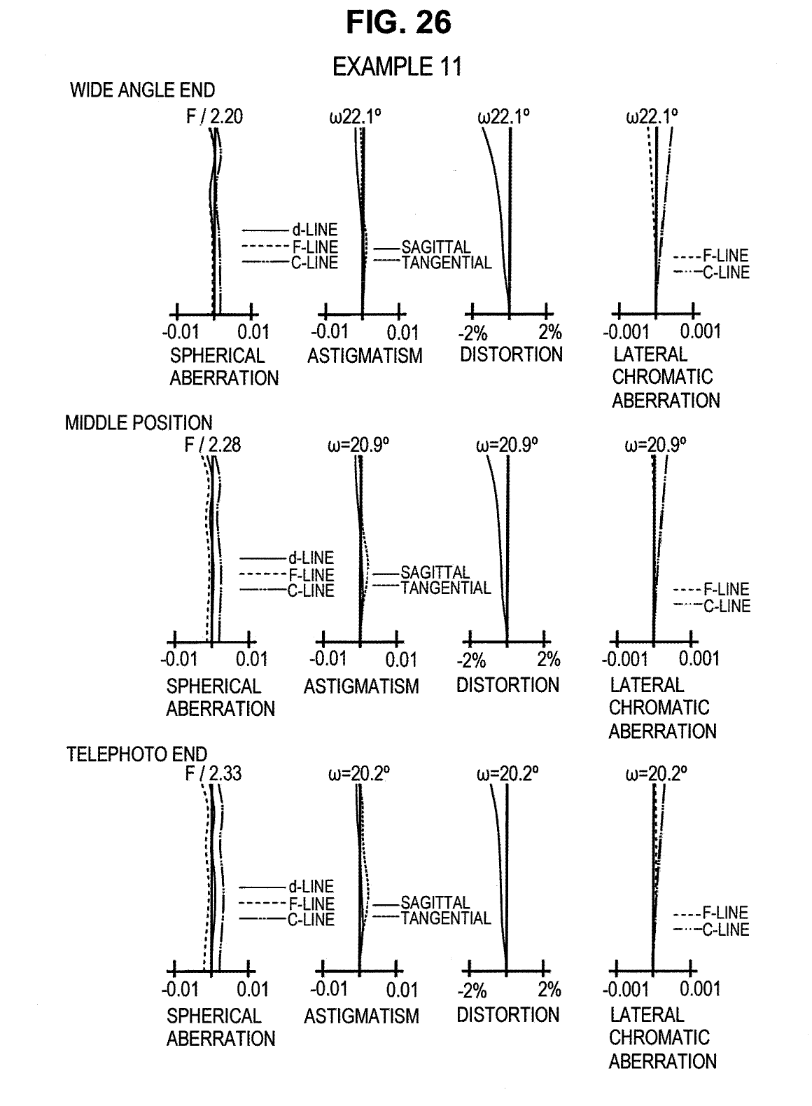

FIG. 26 is an aberration diagram illustrating all aberrations (spherical aberration, astigmatism, distortion, and lateral chromatic aberration) of the projection variable focus lens according to Example 11 at the wide angle end (wide), the middle position (middle), and the telephoto end (tele).

As can be seen from FIG. 26, the projection variable focus lens according to Example 11 has an angle of view 2ω of 44.2 degrees, which is a wide angle, and an F number of 2.20, which is a large value, at the wide angle end. Therefore, all aberrations are effectively corrected.

In addition, as shown in Table 16, the projection variable focus lens according to Example 11 satisfies all of Conditional expressions 1 and 2 and Conditional expressions 1′ and 2′.

### Example 12

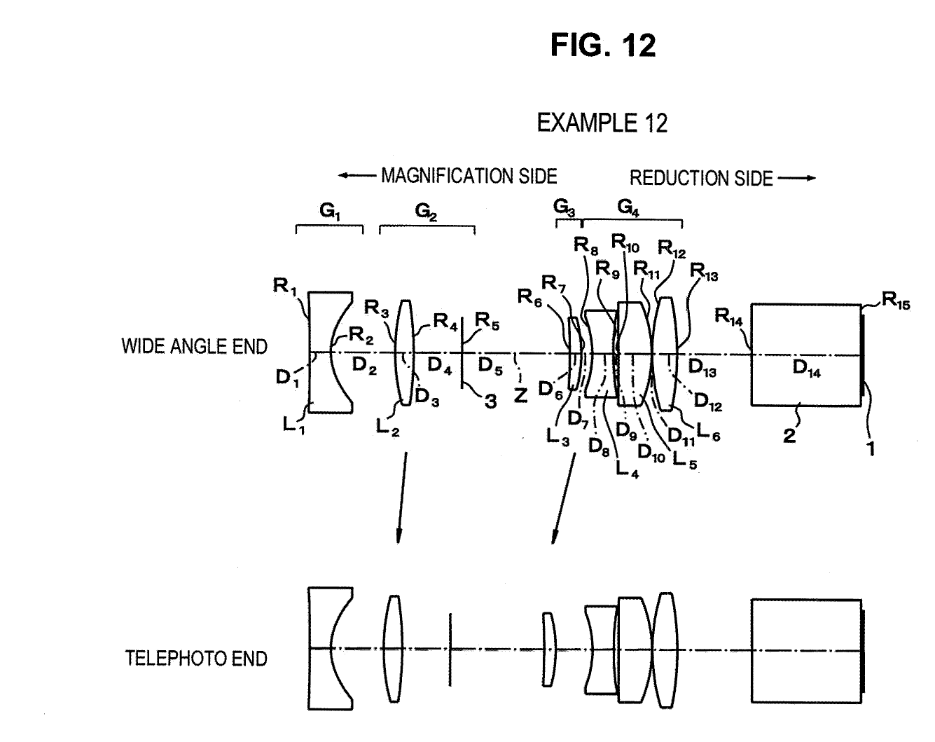

The projection variable focus lens according to Example 12 has the structure shown in FIG. 12.

That is, the projection variable focus lens has substantially the same structure as that according to Example 11 except that the first lens L₁ is an aspheric biconcave lens (on the axis), the second lens L₂ is a spherical biconvex lens, the third lens L₃ is a positive meniscus lens having a convex surface facing the reduction side, and the sixth lens L₆ is a biconvex lens.

Similar to Example 11, when power varies from the wide angle end to the telephoto end, the second lens group G₂ and the third lens group G₃ are moved to the magnification side along the optical axis Z.

Focusing is performed by moving the third lens group G₃ in the direction of the optical axis Z (varifocal lens type).

In Table 12, an upper part shows the curvature radius R of each lens surface according to Example 12, the thickness of the center of each lens and the air space D between the lenses, and the refractive index Nd and the Abbe number νd of each lens with respect to the d-line.

In Table 12, a middle part shows the variable spacing 1, the variable spacing 2, and the variable spacing 3 at the wide angle end (wide), the middle position (middle), and the telephoto end (tele). In Table 12, a lower part shows the values of the constants K and A₃ to A₁₆ corresponding to the aspheric surfaces.

TABLE 12
Focal length F = 1.00~1.06~1.10

| Surface | R | D | Nd | νd |
|---|---|---|---|---|
| 1* | −53.562 | 0.207 | 1.4910 | 57.6 |
| 2* | 0.585 | (Movement 1) | | |
| 3 | 1.981 | 0.184 | 1.8040 | 46.6 |
| 4 | −3.313 | 0.477 | | |
| 5 (Mask) | ∞ | (Movement 2) | | |
| 6 | −6.450 | 0.114 | 1.5891 | 61.1 |
| 7 | −1.350 | (Movement 3) | | |
| 8 | −0.976 | 0.207 | 1.8052 | 25.4 |
| 9 | 2.501 | 0.050 | | |
| 10 | 307.682 | 0.329 | 1.7130 | 53.9 |
| 11 | −1.256 | 0.004 | | |
| 12 | 1.862 | 0.247 | 1.7432 | 49.3 |
| 13 | −2.758 | 0.715 | | |
| 14 | ∞ | 1.077 | 1.5163 | 64.1 |
| 15 | ∞ | | | |

| | Wide | Middle | Telephoto |
|---|---|---|---|
| Movement spacing | angle end | position | end |
| Movement 1 | 0.632 | 0.560 | 0.518 |
| Movement 2 | 1.058 | 0.976 | 0.920 |
| Movement 3 | 0.108 | 0.262 | 0.360 |

Aspheric coefficient

| Surface number | K | A₃ | A₄ | A₅ | A₆ |
|---|---|---|---|---|---|
| 1 | 1.00000 | −6.89695E−04 | 8.90439E−03 | −3.00819E−01 | 8.89703E−01 |
| | A₇ | A₈ | A₉ | A₁₀ | A₁₁ |
| | −2.14661E+00 | 2.25513E+00 | −5.52501E+00 | 2.03301E+01 | −3.35261E+01 |
| | A₁₂ | A₁₃ | HD 14 | A₁₅ | A₁₆ |
| | 3.14927E+01 | 1.70905E+02 | −8.55800E+02 | 1.30950E+03 | −6.68932E+02 |
| | K | A₃ | A₄ | A₅ | A₆ |
| 2 | 1.00000 | 6.79060E−02 | −1.17896E+00 | 2.79239E+00 | −4.98717E+00 |
| | A₇ | A₈ | A₉ | A₁₀ | A₁₁ |
| | −4.40332E+00 | −6.48054E+00 | 3.44354E+01 | 5.72872E+01 | 7.10163E+01 |
| | A₁₂ | A₁₃ | HD 14 | A₁₅ | A₁₆ |
| | −7.19455E+02 | −3.48745E+01 | −3.44443E+02 | 6.94228E+03 | −7.89010E+03 |

*Aspheric surface

In addition, Table 16 shows numerical values corresponding to the conditional expressions according to Example 12.

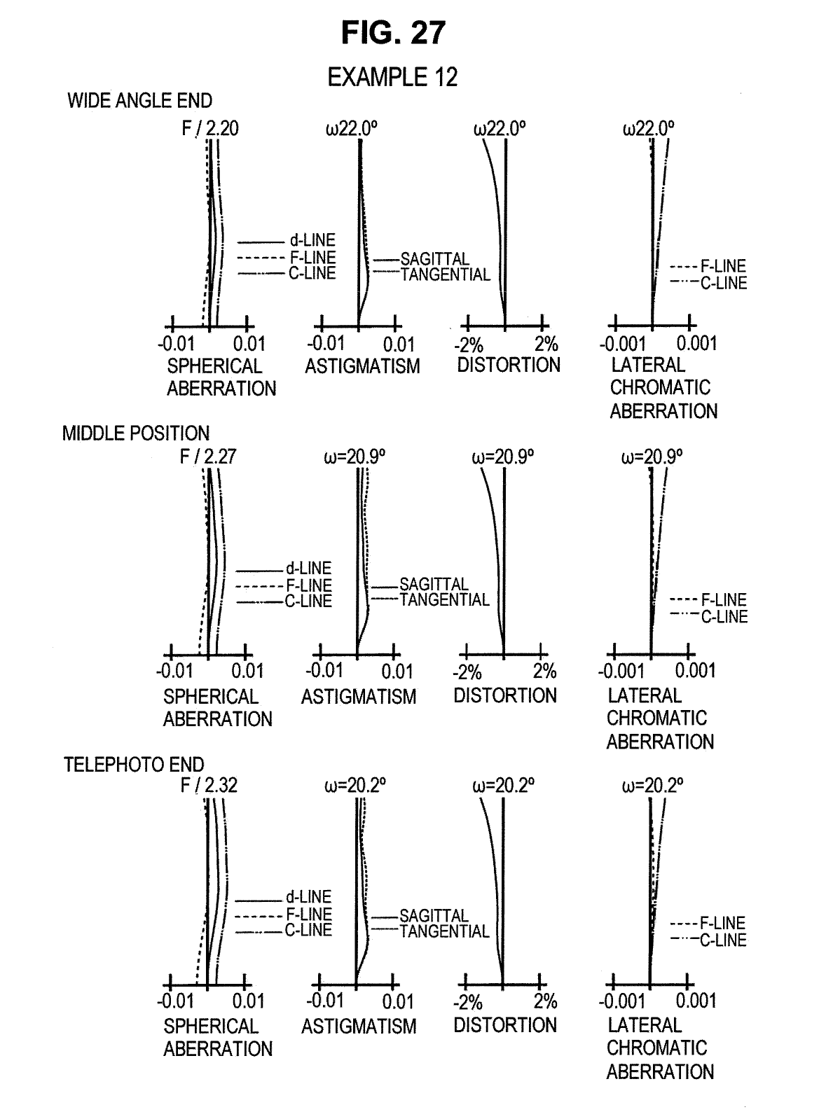

FIG. 27 is an aberration diagram illustrating all aberrations (spherical aberration, astigmatism, distortion, and lateral chromatic aberration) of the projection variable focus lens according to Example 12 at the wide angle end (wide), the middle position (middle), and the telephoto end (tele).

As can be seen from FIG. 27, the projection variable focus lens according to Example 12 has an angle of view 2ω of 44.0 degrees, which is a wide angle, and an F number of 2.20, which is a large value, at the wide angle end. Therefore, all aberrations are effectively corrected.

In addition, as shown in Table 16, the projection variable focus lens according to Example 12 satisfies all of Conditional expressions 1 and 2 and Conditional expressions 1′ and 2′.

### Example 13

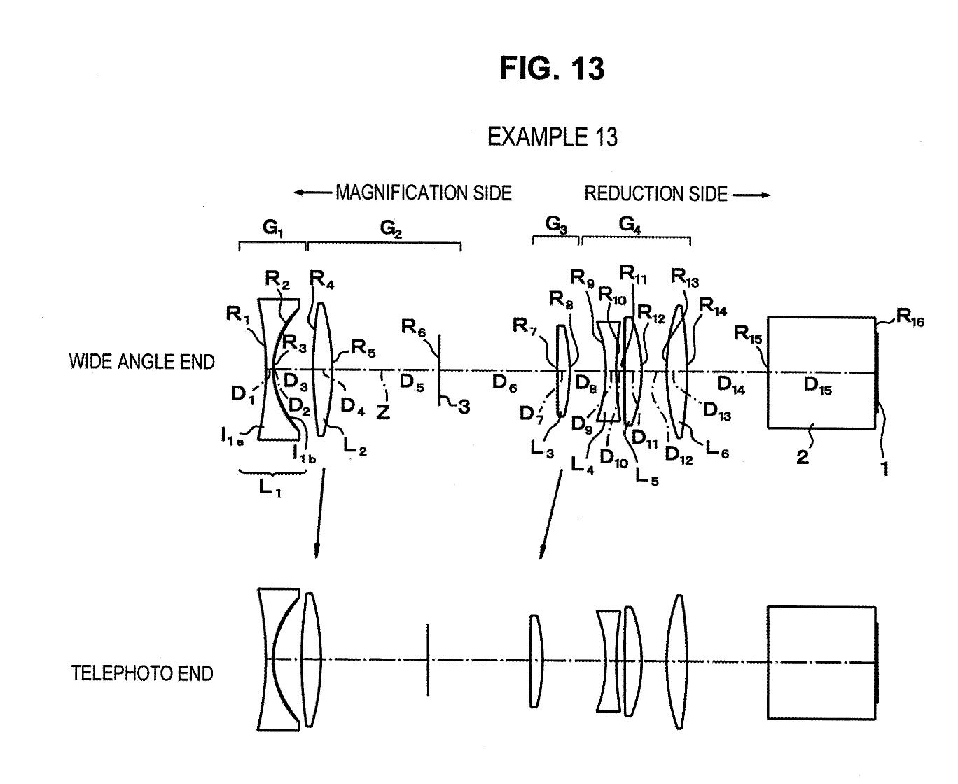

The projection variable focus lens according to Example 13 has the structure shown in FIG. 13.

That is, the projection variable focus lens has substantially the same structure as that according to Example 11 except that the first lens L₁ is a composite aspheric surface lens (the surface closest to the reduction side is an aspheric surface), the mask 3 is provided in the second lens group G₂, and the fifth lens L₅ is a biconvex lens.

Similar to Example 11, when power varies from the wide angle end to the telephoto end, the second lens group G₂ and the third lens group G₃ are moved to the magnification side along the optical axis Z.

Focusing is performed by moving the third lens group G₃ in the direction of the optical axis Z (varifocal lens type).

In Table 13, an upper part shows the curvature radius R of each lens surface according to Example 13, the thickness of the center of each lens and the air space D between the lenses, and the refractive index Nd and the Abbe number νd of each lens with respect to the d-line.

In Table 13, a middle part shows the variable spacing 1, the variable spacing 2, and the variable spacing 3 at the wide angle end (wide), the middle position (middle), and the telephoto end (tele). In Table 13, a lower part shows the values of the constants K and A₃ to A₁₆ corresponding to the aspheric surfaces.

TABLE 13
Focal length F = 1.00~1.06~1.10

| Surface | R | D | Nd | νd |
|---|---|---|---|---|
| 1 | −3.146 | 0.070 | 1.4875 | 70.2 |
| 2 | 0.865 | 0.004 | 1.5277 | 41.9 |
| 3* | 0.722 | (Movement 1) | | |
| 4 | 4.392 | 0.191 | 1.8040 | 46.6 |
| 5 | −2.459 | 1.076 | | |
| 6 (Mask) | ∞ | (Movement 2) | | |
| 7 | 16.000 | 0.124 | 1.6968 | 55.5 |
| 8 | −1.840 | (Movement 3) | | |
| 9 | −1.383 | 0.104 | 1.7847 | 26.3 |
| 10 | 2.949 | 0.081 | | |
| 11 | 35.892 | 0.169 | 1.7292 | 54.7 |
| 12 | −1.505 | 0.253 | | |
| 13 | 2.065 | 0.203 | 1.7292 | 54.7 |
| 14 | −3.970 | 0.816 | | |
| 15 | ∞ | 1.076 | 1.5163 | 64.1 |
| 16 | ∞ | | | |

| | Wide | Middle | Telephoto |
|---|---|---|---|
| Movement spacing | angle end | position | end |
| Movement 1 | 0.399 | 0.325 | 0.285 |
| Movement 2 | 1.188 | 1.093 | 1.029 |
| Movement 3 | 0.365 | 0.534 | 0.638 |

Aspheric coefficient

| Surface number | K | A₃ | A₄ | A₅ | A₆ |
|---|---|---|---|---|---|
| 3 | 1.00000 | −1.10805E−02 | −3.27216E−01 | 5.76236E−02 | −6.83039E−01 |
| | A₇ | A₈ | A₉ | A₁₀ | A₁₁ |
| | −1.29149E−01 | 7.26689E−01 | 5.77296E−01 | −1.07845E+00 | −3.73732E+00 |
| | A₁₂ | A₁₃ | HD 14 | A₁₅ | A₁₆ |
| | −4.42580E+00 | 1.38240E+00 | 1.61748E+01 | 2.55214E+01 | −5.59121E+01 |

*Aspheric surface

In addition, Table 16 shows numerical values corresponding to the conditional expressions according to Example 13.

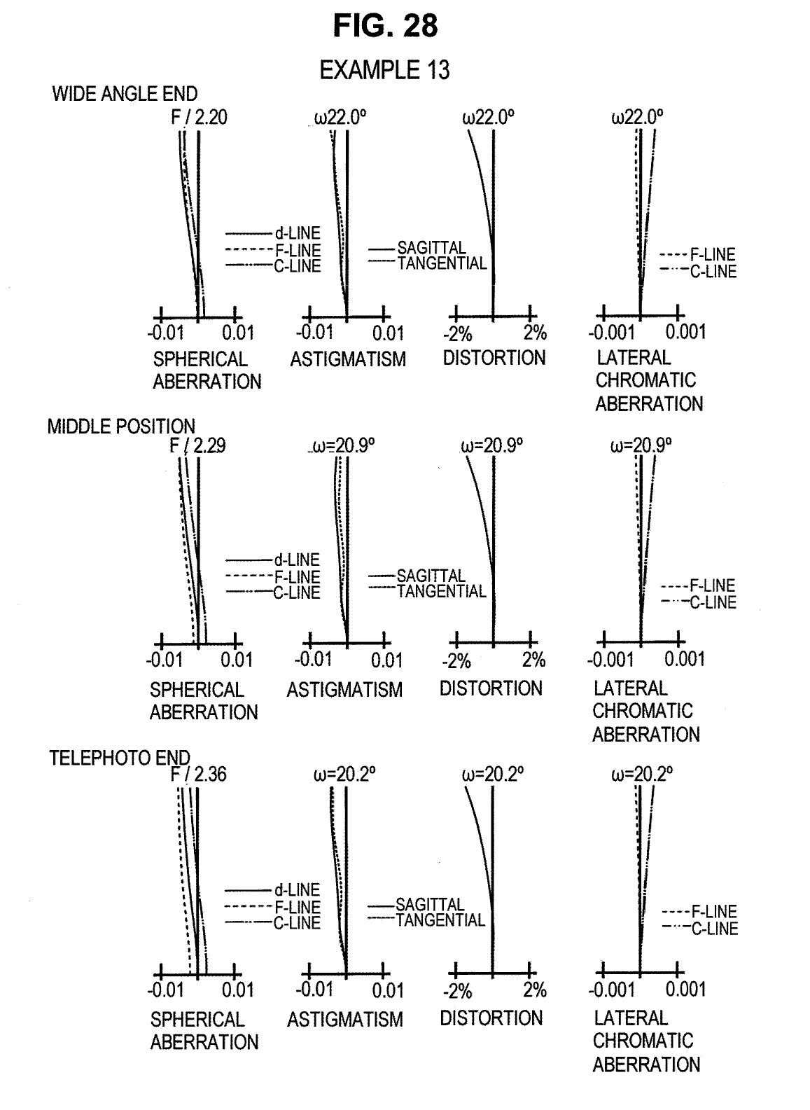

FIG. 28 is an aberration diagram illustrating all aberrations (spherical aberration, astigmatism, distortion, and lateral chromatic aberration) of the projection variable focus lens according to Example 13 at the wide angle end (wide), the middle position (middle), and the telephoto end (tele).

As can be seen from FIG. 28, the projection variable focus lens according to Example 13 has an angle of view 2ω of 44.0 degrees, which is a wide angle, and an F number of 2.20, which is a large value, at the wide angle end. Therefore, all aberrations are effectively corrected.

In addition, as shown in Table 16, the projection variable focus lens according to Example 13 satisfies all of Conditional expressions 1 and 2 and Conditional expressions 1′ and 2′.

### Fifth Example Group

A fifth example group includes a projection variable focus lens according to Example 14. The projection variable focus lens includes a first lens group G₁ including a first lens L₁, a second lens group G₂ including a second lens L₂ and a third lens L₃, a third lens group G₃ including a fourth lens L₄ and a fifth lens L₅, and a fourth lens group G₄ including a sixth lens L₆. When power varies, the second lens group G₂ and the third lens group G₃ are independently moved.

### Example 14

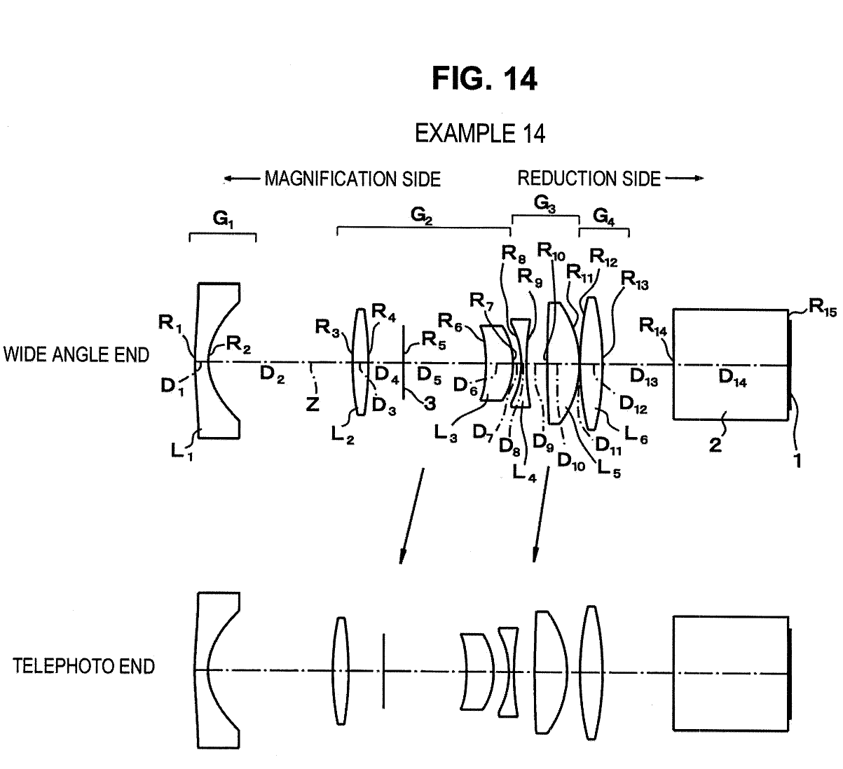

The projection variable focus lens according to Example 14 has the structure shown in FIG. 14.

That is, the projection variable focus lens includes the first to sixth lenses L₁ to L₆ of the first to fourth lens groups G₁ to G₄ arranged in this order from the magnification side. The first lens group G₁ includes the first lens L₁ which is a negative meniscus lens (on the axis) having aspheric surfaces at both sides, one of which is a concave surface facing the reduction side. The second lens group G₂ includes the second lens L₂, which is a biconvex lens, the mask 3, and the third lens L₃, which is a negative meniscus lens (on the axis) having aspheric surfaces at both sides, one of which is a convex surface facing the reduction side. The third lens group G₃ includes the fourth lens L₄, which is a biconcave lens, and the fifth lens L₅, which is a biconvex lens. The fourth lens group G₄ includes the sixth lens L₆ which is a biconvex lens.

When power varies from the wide angle end to the telephoto end, the second lens group G₂ and the third lens group G₃ are moved to the magnification side along the optical axis Z.

Focusing is performed by moving the third lens group G₃ in the direction of the optical axis Z (varifocal lens type).

In Table 14, an upper part shows the curvature radius R of each lens surface according to Example 14, the thickness of the center of each lens and the air space D between the lenses, and the refractive index Nd and the Abbe number νd of each lens with respect to the d-line.

In Table 14, a middle part shows the variable spacing 1, the variable spacing 2, and the variable spacing 3 at the wide angle end (wide), the middle position (middle), and the telephoto end (tele). In Table 14, a lower part shows the values of the constants K and A₃ to A₁₆ corresponding to the aspheric surfaces.

TABLE 14
Focal length F = 1.00~1.06~1.10

| Surface | R | D | Nd | νd |
|---|---|---|---|---|
| 1* | 2.353 | 0.157 | 1.4910 | 57.6 |
| 2* | 0.591 | (Movement 1) | | |
| 3 | 3.185 | 0.189 | 1.7995 | 42.2 |
| 4 | −4.087 | 0.419 | | |
| 5 (Mask) | ∞ | 0.987 | | |
| 6* | −2.101 | 0.325 | 1.5686 | 58.6 |
| 7* | −0.857 | (Movement 2) | | |
| 8 | −0.988 | 0.060 | 1.7847 | 26.3 |
| 9 | 3.010 | 0.241 | | |
| 10 | 12.740 | 0.386 | 1.6204 | 60.3 |
| 11 | −1.221 | (Movement 3) | | |
| 12 | 3.351 | 0.268 | 1.6204 | 60.3 |
| 13 | −3.488 | 0.840 | | |
| 14 | ∞ | 1.362 | 1.5163 | 64.1 |
| 15 | ∞ | | | |

| | Wide | Middle | Telephoto |
|---|---|---|---|
| Movement spacing | angle end | position | end |
| Movement 1 | 1.719 | 1.575 | 1.486 |
| Movement 2 | 0.099 | 0.149 | 0.184 |
| Movement 3 | 0.005 | 0.100 | 0.154 |

Aspheric coefficient

| Surface number | K | A₃ | A₄ | A₅ | A₆ |
|---|---|---|---|---|---|
| 1 | 5.84333 | −4.72375E−01 | 1.31878E+00 | −2.85396E+00 | 1.95256E+00 |
| | A₇ | A₈ | A₉ | A₁₀ | A₁₁ |
| | 1.00428E+00 | 1.66377E−01 | −2.74193E+00 | 3.31915E−01 | −3.12863E+00 |
| | A₁₂ | A₁₃ | HD 14 | A₁₅ | A₁₆ |
| | 6.19419E+00 | 1.51390E+01 | −4.22333E+01 | 3.58358E+01 | −1.08915E+01 |
| | K | A₃ | A₄ | A₅ | A₆ |
| 2 | 0.51188 | −5.26652E−01 | 1.27248E+00 | −1.98898E+00 | −2.93381E+00 |
| | A₇ | A₈ | A₉ | A₁₀ | A₁₁ |
| | 7.06124E+00 | 1.80073E+00 | −6.15633E+00 | −8.34407E+00 | 1.09930E+01 |
| | A₁₂ | A₁₃ | HD 14 | A₁₅ | A₁₆ |
| | −1.82995E+01 | 3.95402E+01 | −4.89590E+01 | 6.63437E+01 | −4.71991E+01 |
| | K | A₃ | A₄ | A₅ | A₆ |
| 6 | 1.00000 | 0.00000E+00 | −3.32859E−01 | −5.08446E−01 | 4.37618E+00 |
| | A₇ | A₈ | A₉ | A₁₀ | |
| | −1.45735E+01 | −8.68364E+00 | 9.96493E+01 | −1.25968E+02 | |
| | K | A₃ | A₄ | A₅ | A₆ |
| 7 | 1.00000 | 0.00000E+00 | −6.45976E−02 | 4.53083E−02 | −3.24105E−01 |
| | A₇ | A₈ | A₉ | A₁₀ | |
| | −3.11681E−01 | 1.16328E+00 | −3.17226E+00 | −1.44426E−01 | |

*Aspheric surface

In addition, Table 16 shows numerical values corresponding to the conditional expressions according to Example 14.

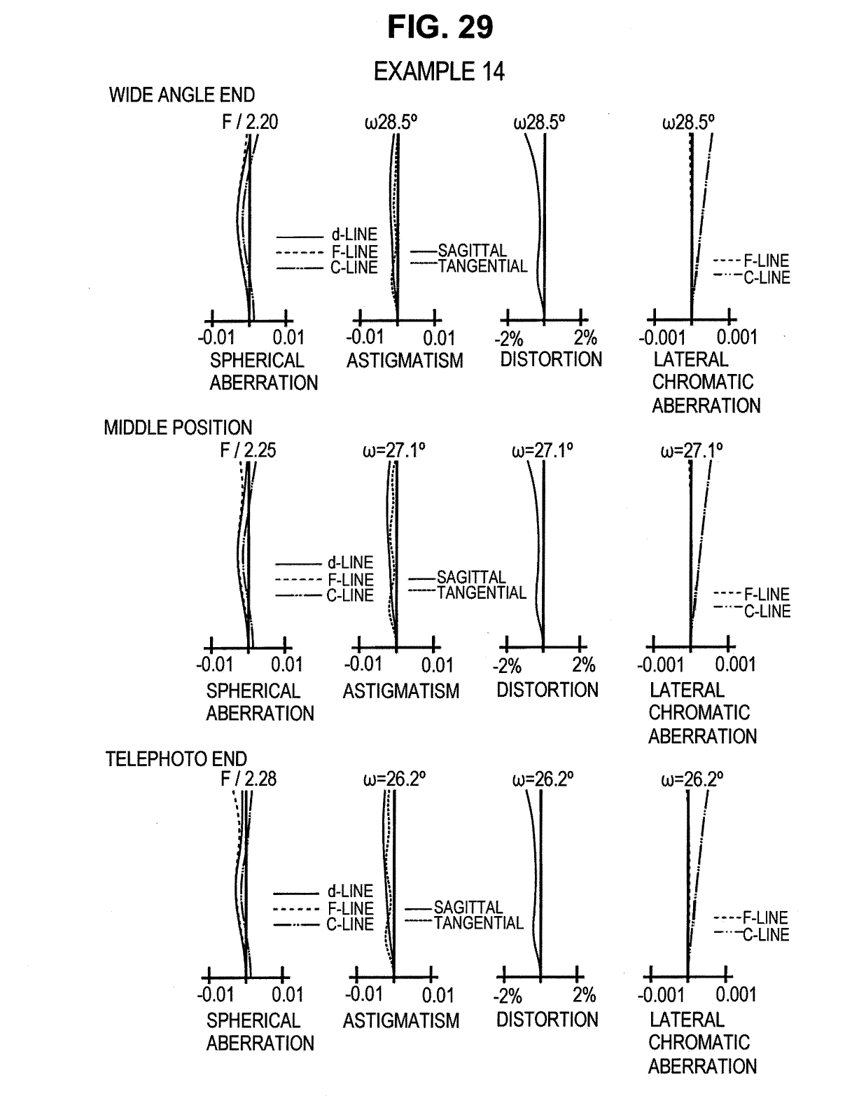

FIG. 29 is an aberration diagram illustrating all aberrations (spherical aberration, astigmatism, distortion, and lateral chromatic aberration) of the projection variable focus lens according to Example 14 at the wide angle end (wide), the middle position (middle), and the telephoto end (tele).

As can be seen from FIG. 29, the projection variable focus lens according to Example 14 has an angle of view 2ω of 57.0 degrees, which is a wide angle, and an F number of 2.20, which is a large value, at the wide angle end. Therefore, all aberrations are effectively corrected.

In addition, as shown in Table 16, the projection variable focus lens according to Example 14 satisfies all of Conditional expressions 1 and 2 and Conditional expressions 1′ and 2′.

### Sixth Example Group

A sixth example group includes a projection variable focus lens according to Example 15. The projection variable focus lens includes a first lens group G₁ including a first lens L₁, a second lens group G₂ including a second lens L₂, a third lens group G₃ including a third lens L₃, a fourth lens group G₄ including a fourth lens L₄ and a fifth lens L₅, and a fifth lens group G₅ including a sixth lens L₆. When power varies, the second lens group G₂, the third lens group G₃, and the fourth lens group G₄ are independently moved.

### Example 15

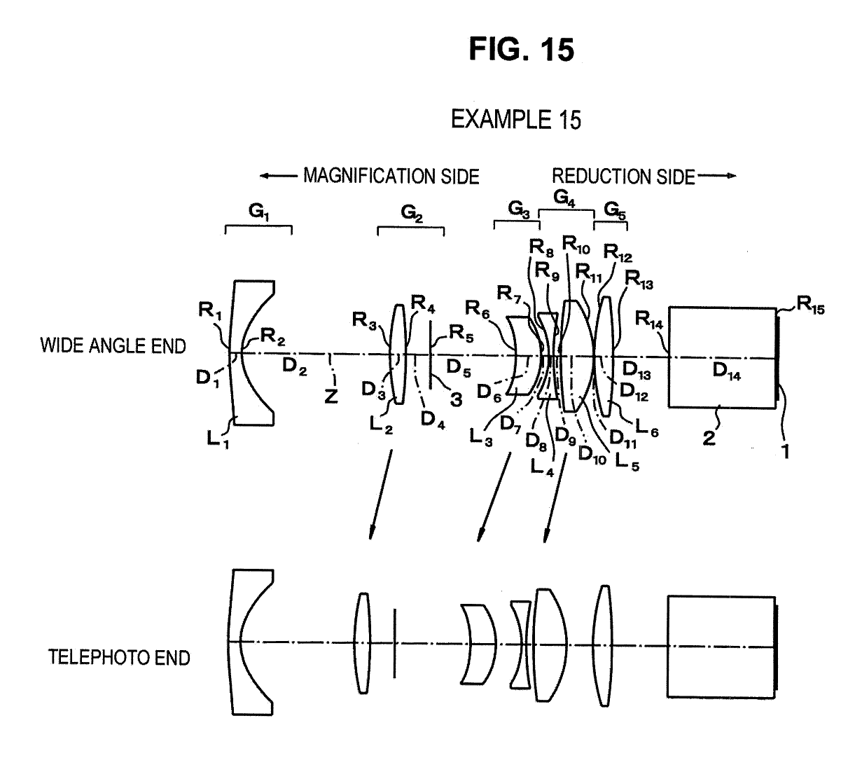

The projection variable focus lens according to Example 15 has the structure shown in FIG. 15.

That is, the projection variable focus lens includes the first to sixth lenses L₁ to L₆ of the first to fifth lens groups G₁ to G₅ arranged in this order from the magnification side. The first lens group G₁ includes the first lens L₁ which is a negative meniscus lens (on the axis) having aspheric surfaces at both sides, one of which is a concave surface facing the reduction side. The second lens group G₂ includes the second lens L₂, which is a biconvex lens and the mask 3. The third lens group G₃ includes the third lens L₃ which is a positive meniscus lens (on the axis) having aspheric surfaces at both sides, one of which is a convex surface facing the reduction side. The fourth lens group G₄ includes the fourth lens L₄, which is a biconcave lens, and the fifth lens L₅, which is a biconvex lens. The fifth lens group G₅ includes the sixth lens L₆ which is a biconvex lens.

When power varies from the wide angle end to the telephoto end, the second lens group G₂, the third lens group G₃, and the fourth lens group G₄ are moved to the magnification side along the optical axis Z.

Focusing is performed by moving the first lens group G₁ in the direction of the optical axis Z (varifocal lens type).

In Table 15, an upper part shows the curvature radius R of each lens surface according to Example 15, the thickness of the center of each lens and the air space D between the lenses, and the refractive index Nd and the Abbe number νd of each lens with respect to the d-line.

In Table 15, a middle part shows the variable spacing 1, the variable spacing 2, the variable spacing 3, and a variable spacing 4 (the gap between the fourth lens group G₄ and the fifth lens group G₅: movement 4) at the wide angle end (wide), the middle position (middle), and the telephoto end (tele). In Table 15, a lower part shows the values of the constants K and A₃ to A₁₆ corresponding to the aspheric surfaces.

TABLE 15
Focal length F = 1.00~1.12~1.20

| Surface | R | D | Nd | νd |
|---|---|---|---|---|
| 1* | 2.288 | 0.157 | 1.4910 | 57.6 |
| 2* | 0.630 | (Movement 1) | | |
| 3 | 2.707 | 0.203 | 1.8040 | 46.6 |
| 4 | −5.081 | 0.314 | | |
| 5 (Mask) | ∞ | (Movement 2) | | |
| 6* | −1.347 | 0.325 | 1.5686 | 58.6 |
| 7* | −0.876 | (Movement 3) | | |
| 8 | −0.975 | 0.060 | 1.7847 | 26.3 |
| 9 | 2.891 | 0.091 | | |
| 10 | 5.155 | 0.425 | 1.7130 | 53.9 |
| 11 | −1.230 | (Movement 4) | | |
| 12 | 2.576 | 0.243 | 1.6779 | 55.3 |
| 13 | −6.009 | 0.701 | | |
| 14 | ∞ | 1.362 | 1.5163 | 64.1 |
| 15 | ∞ | | | |

| | Wide | Middle | Telephoto |
|---|---|---|---|
| Movement spacing | angle end | position | end |
| Movement 1 | 1.895 | 1.613 | 1.453 |
| Movement 2 | 1.092 | 1.014 | 0.968 |
| Movement 3 | 0.098 | 0.234 | 0.331 |
| Movement 4 | 0.005 | 0.230 | 0.338 |

Aspheric coefficient

| Surface number | K | A₃ | A₄ | A₅ | A₆ |
|---|---|---|---|---|---|
| 1 | 5.25849 | −4.06599E−01 | 1.17132E+00 | −2.64270E+00 | 1.89154E+00 |
| | A₇ | A₈ | A₉ | A₁₀ | A₁₁ |
| | 8.94908E−01 | 1.31256E−01 | −2.69210E+00 | 4.46859E−01 | −3.05975E+00 |
| | A₁₂ | A₁₃ | HD 14 | A₁₅ | A₁₆ |
| | 6.22047E+00 | 1.51110E+01 | −4.27021E+01 | 3.60277E+01 | −1.07103E+01 |
| | K | A₃ | A₄ | A₅ | A₆ |
| 2 | 0.54306 | −4.49436E−01 | 1.09437E+00 | −1.75684E+00 | −2.42435E+00 |
| | A₇ | A₈ | A₉ | A₁₀ | A₁₁ |
| | 6.34532E+00 | 9.13116E−01 | −5.84280E+00 | −6.63816E+00 | 1.29868E+01 |
| | A₁₂ | A₁₃ | HD 14 | A₁₅ | A₁₆ |
| | −1.82286E+01 | 3.67360E+01 | −5.49359E+01 | 6.36578E+01 | −3.55717E+01 |
| | K | A₃ | A₄ | A₅ | A₆ |
| 6 | 1.00000 | 0.00000E+00 | −1.14423E−01 | −1.56568E+00 | 6.49675E+00 |
| | A₇ | A₈ | A₉ | A₁₀ | |
| | −1.07173E+01 | −1.57634E+01 | 7.15753E+01 | −7.17586E+01 | |
| | K | A₃ | A₄ | A₅ | A₆ |
| 7 | 1.00000 | 0.00000E+00 | 5.05509E−03 | −2.28039E−01 | −3.26142E−01 |
| | A₇ | A₈ | A₉ | A₁₀ | |
| | 2.26848E+00 | 5.02060E−01 | −1.62311E+01 | 1.73166E+01 | |

*Aspheric surface

In addition, Table 16 shows numerical values corresponding to the conditional expressions according to Example 15.

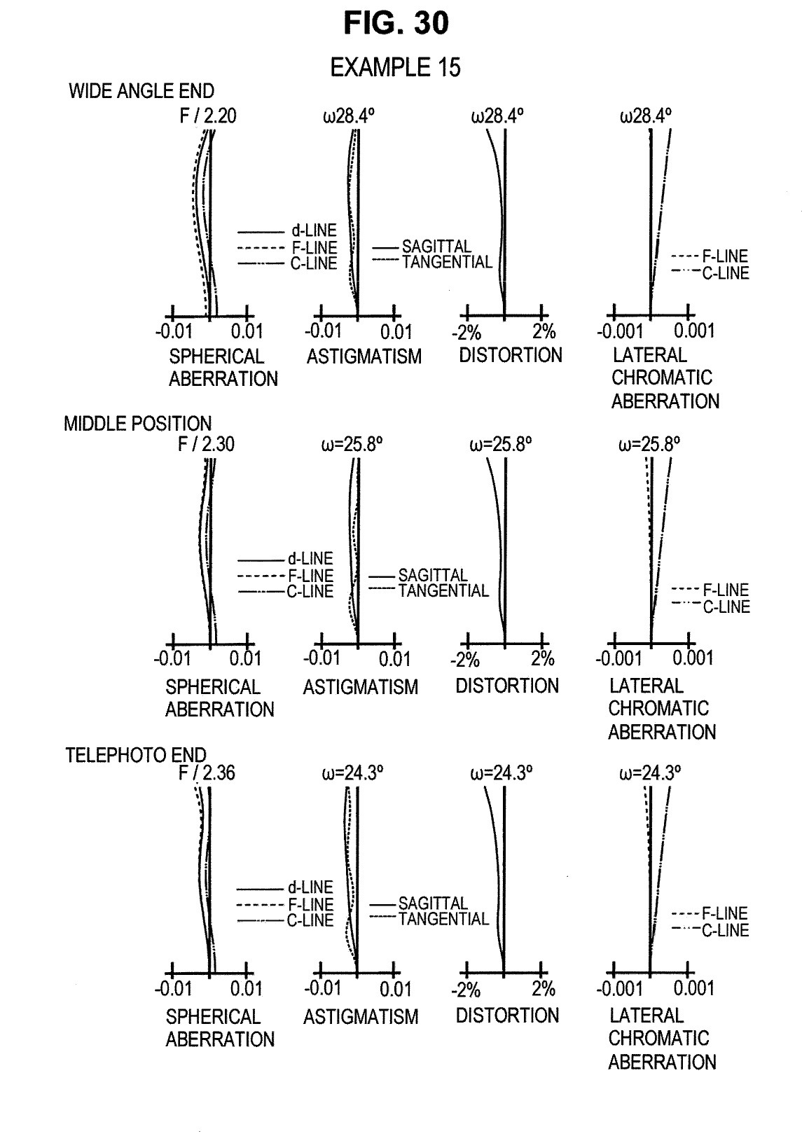

FIG. 30 is an aberration diagram illustrating all aberrations (spherical aberration, astigmatism, distortion, and lateral chromatic aberration) of the projection variable focus lens according to Example 15 at the wide angle end (wide), the middle position (middle), and the telephoto end (tele).

As can be seen from FIG. 30, the projection variable focus lens according to Example 15 has an angle of view 2ω of 56.8 degrees, which is a wide angle, and an F number of 2.20, which is a large value, at the wide angle end. Therefore, all aberrations are effectively corrected.

In addition, as shown in Table 16, the projection variable focus lens according to Example 15 satisfies all of Conditional expressions 1 and 2 and Conditional expressions 1′ and 2′.

TABLE 16

| | (1) | (2) |
|---|---|---|
| Conditional expression | f₁/f_{w} | f₂/f_{w} |
| Upper limit | −2.5 | 1.0 |
| Lower limit | −0.5 | 4.0 |
| Example 1 | −1.628 | 2.312 |
| Example 2 | −1.597 | 2.360 |
| Example 3 | −1.444 | 2.022 |
| Example 4 | −1.347 | 2.549 |
| Example 5 | −1.531 | 1.950 |
| Example 6 | −1.512 | 2.274 |
| Example 7 | −1.589 | 2.904 |
| Example 8 | −1.239 | 2.433 |
| Example 9 | −1.627 | 2.270 |
| Example 10 | −1.198 | 2.053 |
| Example 11 | −1.178 | 2.249 |
| Example 12 | −1.177 | 1.566 |
| Example 13 | −1.184 | 1.986 |
| Example 14 | −1.657 | 2.265 |
| Example 15 | −1.827 | 2.223 |

What is claimed is:

1. A projection variable focus lens comprising:
six lenses including
a first lens that is provided closest to a magnification side and has a negative refractive power, and
a second lens from the magnification side that has a positive refractive power and is telecentric on a reduction side, wherein
the six lenses are classified into three or more lens groups,
three or less of the three or more lens groups are moved to change a focal length, and
when the focal length varies from a wide angle end to a telephoto end, the second lens is moved from the reduction side to the magnification side along an optical axis.

2. The projection variable focus lens according to claim 1, wherein
the three or more lens groups includes a first lens group including the first lens, and
the first lens group satisfies the following conditional expression:
−2.5<f₁/f_{w}<−0.5
where f_{w} indicates the focal length of the entire system at the wide angle end, and
f₁ indicates a focal length of the first lens.

3. The projection variable focus lens according to claim 2, wherein
the three or more lens groups include a second lens group that is arranged on the reduction side of the first lens group, and
the second lens group satisfies the following conditional expression:
1.0<f₂/f_{w}<4.0
where f_{w} indicates the focal length of the entire system at the wide angle end, and
f₂ indicates a focal length of the second lens.

4. The projection variable focus lens according to claim 1, wherein
the lens groups includes
a first lens group having the first lens, and
a second lens group that is arranged on the reduction side of the first lens group, and the second lens group satisfies the following conditional expression:
1.0<f₂/f_{w}<4.0
where f_{w} indicates the focal length of the entire system at the wide angle end, and
f₂ indicates a focal length of the second lens.

5. The projection variable focus lens according to claim 1,
wherein the first lens has at least one aspheric surface.

6. The projection variable focus lens according to claim 1,
wherein the six lenses include a third lens from the magnification side that has a positive refractive power and includes a convex surface facing the reduction side.

7. The projection variable focus lens according to claim 1,
wherein the six lenses include
a fourth lens from the magnification side that has a negative refractive power,
a fifth lens from the magnification side that has a positive refractive power, and
a sixth lens from the magnification side that has a positive refractive power.

8. A projection display device comprising:
a light source;
a light valve;
an illumination optical unit that guides light emitted from the light source to the light valve; and
the projection variable focus lens according to claim 1,
wherein the light valve modulates the light emitted from the light source, and
the modulated light is projected onto a screen by the projection variable focus lens.
